(19) United States
(12) Patent Application Publication
(10) Pub. No.: US 2019/0154791 A1
(43) Pub. Date: May 23, 2019

(54) THREE-DIMENSIONAL ACOUSTIC DETECTION AND IMAGING VIA HEXIDRANT ISOLATION AND DELAY-MIXING

(71) Applicant: Kelly Jowett, Seattle, WA (US)

(72) Inventor: Kelly Jowett, Seattle, WA (US)

(21) Appl. No.: 16/192,561

(22) Filed: Nov. 15, 2018

Related U.S. Application Data
(60) Provisional application No. 62/590,176, filed on Nov. 22, 2017.

(51) Int. Cl. G01S 3/808; G01S 3/84

(52) U.S. Cl. CPC G01S 3/8083; G01S 3/84

(57) ABSTRACT

A device for the three-dimensional acoustic detection and imaging via hexidrant isolation and delay mixing is comprised of one or more acoustic sensors capable of collecting one or more sets of acoustic data; and a computer processor configured to perform operations including at least: obtaining one or more sets of acoustic data from the one or more acoustic sensors; applying one or more time delays to the one or more sets of acoustic data from the one or more acoustic sensors to create one or more sets of delay data; combining the one or more sets of delay data from the one or more acoustic sensors into one or more sets of output data; and mapping the location of a source of the acoustic data based on the one or more time delays applied.

### PRIORITY CLAIM

This application claims priority to and/or the benefit of U.S. provisional patent application Ser. No. 62/590,176 filed Nov. 22, 2017. The foregoing application is incorporated by reference in its entirety as if fully set forth herein.

### BACKGROUND OF THE INVENTION

This invention relates generally to a device and method for the three-dimensional detection of acoustic waves and the locating and imaging thereof.

### BRIEF SUMMARY

This invention relates generally to a device and method for the three-dimensional detection of acoustic waves and the locating and imaging thereof. Specific details of certain embodiments of the invention are set forth in the following description and in the figures to provide a thorough understanding of such embodiments. The present invention may have additional embodiments, may be practiced without one or more of the details described for any particular described embodiment, or may have any detail described for one particular embodiment practiced with any other detail described for another embodiment.

The growth of modern cities has created numerous noise-related safety hazards for individuals and businesses. In some situations, individuals or groups have used firearms or other dangerous tools against unsuspecting individuals and businesses in loud and crowded areas. There are also many other unsafe situations that can be created by other situations including construction or travel where those in danger may be unable to determine the source of the sound. This has lead in some circumstances to the individuals in those conditions being unable to determine the direction of danger such as the position of a shooter. Similar circumstances are frequently encountered by soldiers in the field, where they may come under fire from hostile forces without being able to identify the hostile forces' location. This situation leads to those in danger being unable to accurately identify where they can seek shelter or escape the hazard without being exposed to further danger. Many current systems that attempt to remedy this issue rely on comparing the difference times in which various noises such as, but not limited to, gunfire, are detected by an array of pre-arranged microphones, making the systems bulky and difficult to reposition, or they rely on large networks of sensors and large amounts of processing power to triangulate sound sources. The present invention allows for accurate detection of noise sources in a device that is portable and capable of being carried by a human user, placed in a particular location, or mounted on a vehicle. Hosts of events such as civic functions, concerts, or other large gatherings, as well as military and law enforcement units, could use the portability of the present device to deploy a detector anywhere or bring it with them, thus ensuring that should they find themselves in danger due to gunfire, explosions, or other dangerous events likely to cause large amounts of noise such as electrical shorts or inclement weather, they would be able to better identify the location of the danger and thus better able to assess the situation and seek shelter in a safe place.

This invention can be configured to attach to a variety of vehicles including, but not limited to, a car, truck, or even helicopter. In situations where the vehicle may be in operation during the use of the device it can be calibrated to compensate for the added noise from the vehicle. In addition, the method of calculation that the present device uses assists in maximizing the detected input from the source of the noise and minimizes other ambient noises, even where they may be much higher than a typical day-to-day noise such as in situations including, but not limited to, the engine of a car, the music of a concert, or the spinning of helicopter blades.

Among its many other uses, the present invention is useful in situations where gunshots are allowed only in designated areas while being restricted to others in close proximity. For example, a firing range would not want a firearm to discharge outside of the designated shooting areas. The present device would be able to easily tell the difference between a firearm discharge in an authorized area versus one in an unauthorized area. For such situations, or for other safety purposes, the present invention could feature an alarm, another form of warning means, or silent alarms to notify relevant personnel when loud events occur in a specific area. In addition, the present invention can be used in firearm target competition settings, differentiating between gunshots originating from individual stalls in a shooting range. In such a situation the device could allow a range-master or other individual to record the number of shots fired from each shooter and potentially monitor the rate of fire of participants. Alternatively, in a construction or public utility setting, the present invention could be utilized to alert workers of the location of a collapsing construction project such as a falling or buckling i-beam, alert utility workers of a damaged transformer, or locate a natural gas line rupture.

The present invention improves on conventional methods of acoustic detection which measure the time difference of arrival times (“TDOA”) of sound waves at certain acoustic sensors. In its simplest form the TDOA determines sound origination locations by measuring Δt, delta t, the time difference in seconds between when two or more sensors detect the sound, which is calculated by taking the distance between the two sensors, multiplied by the cosine of the baseline angle between them and the incident sound, over the speed of sound. Combining the known factors, a user can solve the equation for the cosine of the baseline angle, and from there find the baseline angle. In the present method, the speed of sound may be calculated or assumed given an initial speed of sound constant, though the calculations or assumptions can be modified based on the medium in the location being monitored or based on ambient area data detected by sensors, and an artificial delay is input into the data of the first and all but the last acoustic sensors to detect a sound so that the waveforms are constructively added to the original waveform to assist in distilling the incident noise from the surrounding noise.

This system and method combines some of the theory behind TDOA with triangulation principles given that the location of the sensors relative to each other is a known quantity and the speed of sound in a given medium is also known. In one embodiment, the system and method involve inverting part of the traditional TDOA calculation; instead of having a pre-programmed value for the speed of sound and comparing the exact time sounds were received directly, the system utilizes a number of pre-programmed delays that, when combined, correspond to a number of points that approximate the area around the device. The device then, rather than having to wait for each acoustic sensor to detect a sound and then work backwards from there, applies its modifications and delay to the data it receives from the acoustic sensors to be able to listen to multiple locations at the same time. In some embodiments, the system is configured with a number of different delays, each correlated with a direction a sound could be coming from or approximating the area around the device, and when sound is detected the system applies each delay to the sound. Since each delay correlates to a different direction, the direction and intensity of the sound are mapped in two or more dimensions.

In the present invention, rather than relying solely on algorithmic solutions to determine locations, the system compares the amount of constructive interference created when mixing and combining signals together using preset delays. The system can then be supported by utilizing TDOA and/or triangulation principles to improve accuracy and reliability, but it is not required the invention do so.

In some embodiments, the calibration configuration can be modified to account for variations in the medium the signal is traversing. In some embodiments, the device may be further comprised of one or more temperature, pressure and/or humidity sensors which enable the device to predict and/or calculate the necessary delays based on the variations in the local speed of sound. In some embodiments, the device can be calibrated for use in other sound conducting media including, but not limited to, underwater, inside solids, or other gases or liquids besides typical Earth atmosphere.

By adding different delays, the system can be configured to listen to certain locations. This may be achieved by pre-inputting delays, or partially pre-inputting delays. For example, to create a delay to have the system listen to a location that is in-line with one of the acoustic sensors and at level with it, the delay would be pre-calculated such that it is assumed the sound reaches the acoustic sensor in line with it first, then the other two lower sensors second simultaneously, and the top sensor last; because the speed of sound is known or can be accurately assumed, the delay can be derived from that. The next delay for a location slightly aside from that first location would be input with the presumption that the sound arrives slightly later to the first sensor, to one of the side sensors slightly earlier and the other later, and to the top sensor later still depending on how far to the side the delay is being calculated. In some embodiments the system can be pre-programmed with the current constants for the speed of sound based on factors including, but not limited to, temperature, humidity and atmospheric pressure, or the system can include sensors capable of detecting such factors and internally adjusting the delays.

The delays utilized in the present invention could be conceived as a reversal of the traditional acoustic location calculation, wherein rather than utilizing the delay between each sensor to triangulate the location of the sound, the delays, pre-programmed as one or more sets, are already configured to look at various locations as if sound had come from them, so that instead the device can optionally focus on comparing and calculating the highest recorded intensities by combining the amplitudes of the waveforms after applying the delay to each data set, then comparing which delay set produced the largest amplitude waveform.

This principle of delay mixing can, in some embodiments, be applied to pre-recorded audio to deliver an after-the-fact visual output if the physical orientation is known among the microphones and the digital signal from each microphone includes a shared real-time stamp common among all input channels.

Thus, the system can be configured with a large range of delays so that it is able to generate a sound-intensity map of a three-dimensional area by breaking the area into a three-dimensional region with three or more axes. The system would not be required to actively move the acoustic sensors but instead would be able to view a range of locations by adding different delays to the data collected by the acoustic sensors and using that as its targeting mechanism. In practice, the system functions thusly: a three-dimensional area around the system can be generalized as a sphere divided into a grid; a sound incoming from a specific sector on the grid and be listened to by utilizing a pre-set delay, since a sound's arrival time at each sensor can be predicted; and by then creating a delay for each sector on the grid—by having the delay for each location pre-calculated as if the sound had come from that location—the device can create a three-dimensional map of the area around itself. Combined with proper display software and hardware the device can also create three-dimensional maps with certain sounds sources marked as “hot spots” on a form of heat-map of the local area which can be displayed relative to line-of-sight to the device and/or as a generalized map. In some embodiments, the system could be configured with delays set to detect sound in the full area surrounding the device, but could be specifically programmed to only trigger when sounds were detected in a certain region; such as a specific section of the area represented by a sphere around the device.

The display software and hardware used to display the sound map may include conventional two-dimensional displays configured to map a three-dimensional image onto a two-dimensional area, such as, but not limited to, showing the sound map as a Mercator projection, Gall-Peters projection, or Equirectangular projection. Alternative hardware and software means might include, but are not limited to, augmented reality or virtual reality devices that allow a user to view the sound map in three dimensions, possibly overlaid on an image of the surrounding area or map, or with hardware that allows the user to interact with the map. In some embodiments, the user may take the place of the one or more acoustic sensors, while in other embodiments the user may be able to move around independent of the location of the one or more acoustic detectors.

In some embodiments, the device can be further comprised of an alarm or other communication device configured to send an alarm or warning signal. In such embodiments the alarm may trigger, audibly or silently, upon the detection of a sound anywhere around the device or in a certain region; or a sound of a specified decibel rating. In other such embodiments, the communications device may send an alarm signal to personnel or a computer configured to receive a signal in order to warn relevant people and/or systems as to a sound occurring.

In some embodiments, the device can be combined with software and hardware solutions to isolate certain frequencies and allow for frequency specific delays to reduce error created due to artifacts from resonant frequencies. When searching for specific frequencies the device can be calibrated further to account for the frequency in question, adding a known delay based on the anticipated wavelength and arrival time of the frequency. Alternatively, the device can be configured to only listen for specified frequencies and/or wavelengths, or to look for them specifically in the data to pick them. Alternatively, the device can be configured to only listen for specified frequencies and/or wavelengths, or to look for them specifically in the data to pick them out in particular.

When isolating based on frequency in addition to arrival time the present device is thus capable of creating a sound map that shows the relative strengths of sounds based on audio frequency bands for a given area. In some embodiments, the system may be configured to display the audio frequency strengths in various colors or other means of indicating the strengths of differing sounds. In such embodiments brightness may be associated with the signal strength of the signal after the signals have been combined.

In some embodiments, the system can be configured to ignore certain delays or ranges, thereby saving on processing power and improving overall speed and efficiency of the detection system to allow for a more rapid location. For example, were a user only concerned with sounds emanating from a certain range, such as the 180-degree semi-sphere presently in front of them, the system could be configured to input only delays that would result in sounds from that direction; essentially not triggering on acoustic sounds that are not first detected by the one or more acoustic detectors pointed in that direction.

The delay mixing component of the system can also enable the system to pick specific noises out of an otherwise high level of disruptive background noise. In some embodiments the system applies the delay to the input data received by each sensor and thus the delays allow the waveforms of the sudden, louder noise to constructively interfere, thus making them stand out over varying background noise which will not reach the same peak as the noise being listened for.

In some embodiments the system can be configured to reduce processing demand by taking the data from all the acoustic sensors, adding a pre-set delay to the data from each sensor, combining the delay-added datasets into single waveforms representing constructive interference from each dataset, reviewing each dataset to determine which has the highest recorded input value—in some embodiments this input may be in decibels—, determine which delay was added to the dataset with the highest recorded input value, determine which location that delay was programmed to orient towards, and then set the pixel associated with that location as the brightest. Then the system can look at the pixels around the highest and set their brightness lower relative to the first pixel until the system reaches the lowest recorded input levels, which would be the darkest pixels.

In one embodiment, a device for three-dimensional acoustic detection and imaging via hexidrant isolation and delay mixing is comprised of four acoustic sensors, with one of the four acoustic sensors each positioned at each apex of an equilateral tetrahedron with a number of faces equal to the number of acoustic sensors wherein the apexes are at a distance of one and a half feet from the center of the tetrahedron.

The acoustic sensors may be mounted on pylons or part of a latticework. The pylons may be hollow, solid, or a hybrid of the two. The acoustic sensors may be connected directly to each other by pylons or may be connected to a receiver or base from which the pylons emerge. In some embodiments, the acoustic sensors are mounted on pylons that are one and a half feet from the center of one of the faces. In other embodiments the acoustic sensors are mounted on pylons that are greater than one and a half feet, while in other embodiments the acoustic sensors are mounted on pylons that are shorter than one and a half feet to improve the local resolution. In some embodiments, the acoustic sensors are not mounted on pylons but are connected by wire or wirelessly to a computer or data gathering device. In some embodiments the acoustic sensors may be positioned far away from the data gathering device such as several miles in order to detect and triangulate sounds from a long distance.

In some embodiments the device is an equilateral tetrahedron, while in other embodiments it may be an equilateral or non-equilateral polyhedron such as a pentahedron or hexahedron. In the case of a pentahedron there would be five or six sensors, one at each vertex, depending on the exact shape. In a hexahedron embodiment there would be eight sensors, one at each vertex.

In some embodiments the sensors are acoustic sensors. In some embodiments the sensors may be detect light or other waveforms. In some embodiments, the sensors are protected by windscreens, or may be additionally or alternatively protected by pop shields, pop filters or pop screens.

In some embodiments the device includes a base from which the pylons the sensors are mounted upon emerge. The base may be a variety of shapes including but not limited to a cube, cylinder, prism, hexagonal prism, polyhedron, cone, or other polygonal shape. The base may house some or all of any included computational or electronic components including, but not limited to, digital receivers, computer processors, memory, digital-analog converters, signal receivers, wireless data receivers.

In some embodiments, the acoustic location computation splits the x-y plane into six hexidrants with three of the seven axes emerging from the center and passing through the location of each of the three sensors, and the other three emerge halfway between each pair of sensors. The final sensor emerges from the z axis, perpendicular to the x-y plane. The axes between the sensors may be referred to as ideals because any incoming wave would be detected by the sensors the axes is located between at the same time. In effect, splitting the area around the three lower sensors into hexidrants allows the system to assume the basic direction from which a sound came based on which sensor detects it first. The first sensor to detect a sound thus means the sound came from one of the two hexidrants on either side of that sensor 104. The determination can be further honed by then determining when the other two horizontally aligned sensors detected the sound. If, relative to the sensor that detected the sound first, the one rightwards of it detects the sound second, then it can be presumed that the sound is coming from the right-side hexidrant relative to the first sensor.

In some embodiments, there are certain ideal directional orientations that can be used to calibrate the device. For example, in the equilateral tetrahedron configuration of sensors, there are four imaginary lines that can be drawn from the tetrahedron, emerging perpendicular to the center of each tetrahedron face, where a sound coming towards the device along that line would reach three of the microphones at the exact same time and the fourth microphone last. In that situation three of the microphones would share the exact same delay and the fourth would be opposite of the sound source. If the orientation of the device in real space is known relative to the four ideal directions, the angular difference from any sound from one of the four ideals can be inferred using spherical geometry and the parameters defined in each of the delay sound map pixels.

Therefore, the same assumptive reasoning can be applied to the top sensor; a sound that is detected by a horizontal plane sensor will be detected first by a horizontal plane sensor unless the sound originates from above forty-five degrees over the device, in which case it will be detected by the top sensor before any of the horizontal sensors. In such cases the system can assume the sound is emanating from somewhere in the inverted cone with a forty-five degree slope originating out of the base of the device. Once that assumption is made the system can compute the relative direction based on when the other three sensors detect the sound.

In some embodiments, there are additional sensors and the computation splits the x-y plan, or another similar plane, into more segments based on the number and positioning of the sensors.

In some embodiments, the system is further comprised of a computer processor receives data on the received sounds from the acoustic sensors, and then plots the waveforms of that data to calculate which sensor detected the waveform first, and then calculates the location of the incoming sounds by comparing the times that the other sensors detected the sound to determine its direction based on the known speed of sound. The computer processor may be attached to a separate unit or may be attached to the base of the device.

In some embodiments, the computer processor modifies the incoming sound data by inputting an artificial delay on the first three acoustic sensor waveforms and then combines the resulting waveform, allowing the device to amplify the incoming sound to better detect it from the noise of other incoming sounds. In some embodiments, an attached computer processor could take in data from multiple sounds and combine matching waveforms to generate an image of the surrounding sounds.

In some embodiments, the device includes a computer database and processor configured to compare the waveform of detected acoustic waves to a known library of acoustic waves to determine the cause of the acoustic wave. For example, the database may include data on the report of various firearms, and would be able to display for a user that a detected acoustic wave was likely the sound of a firearm discharging. In some embodiments, the device may include a display screen or other output means to provide information to a user.

In some embodiments, the system can be further configured to convert the output from the delays attached to the input data from the acoustic sensors into a digital video signal by associating a unique set of delays to each pixel and composing an image by plotting the input data with the unique set of delays and plotting that to each pixel. The sample rate of audio is usually much faster than the refresh rate of a television of computer monitor, and thus a significant amount of data is available to create each video frame and for each pixel. For example, with a 96 khz audio sample rate, 1600 samples of audio data would be available to create a single pixel, and from each pixel a frame, of video output at a conventional speed of 60 frames per second.

This device could be used to detect the source of sounds from a remote distance wherein the user is not able to determine the direction on their own. For example, were a shooter to fire upon a loud venue such as a concert, the attendees, security and law enforcement might be unable to determine the direction of the incoming fire from the venue due to ambient noise. This device could detect the direction of the incoming fire and allow law enforcement to locate the shooter, but also allow security and concert attendees to adequately escape the situation or shelter in place without being further exposed.

Alternatively, this device could be used to locate a noise in a faulty vehicle, the location of someone shouting for assistance, or a host of other situations wherein the source of a distinct noise needs to be located either independently or when there is a large amount of ambient noise.

### BRIEF DESCRIPTION OF THE DRAWINGS

Embodiments of the present invention are described in detail below with reference to the following drawings:

FIG. 1 is a perspective view of an acoustic sensor apparatus component 100 of a device and method for the three-dimensional detection of acoustic waves and the locating and imaging thereof, in accordance with an embodiment of the invention;

FIG. 2 is a top view of an acoustic sensor apparatus component 100 of a device and method for the three-dimensional detection of acoustic waves and the locating and imaging thereof, in accordance with an embodiment of the invention;

FIG. 3 is a perspective, scene view of a device and method for the three-dimensional detection of acoustic waves and the locating and imaging thereof in use, in accordance with an embodiment of the invention;

FIG. 4 is a perspective view of an acoustic sensor apparatus component 100 of a device and method for the three-dimensional detection of acoustic waves and the locating and imaging thereof with lines to indicate the division of hexidrants, in accordance with an embodiment of the invention;

FIG. 5 is a top view of an acoustic sensor apparatus component 100 of a device and method for the three-dimensional detection of acoustic waves and the locating and imaging thereof with lines to indicate the division of hexidrants, in accordance with an embodiment of the invention;

FIG. 6 is a flow-chart demonstrating the process showing the detection of input by one or more sensors to the mapping utilizing the digital delays to a single pixel, in accordance with an embodiment of the invention;

FIG. 7 is the data detected by the acoustic sensor apparatus of a device and method for the three-dimensional detection of acoustic waves and the locating and imaging thereof when detecting a sudden, loud noise, in accordance with an embodiment of the invention;

FIG. 8 is the zoomed-in version of the data detected by the acoustic sensor apparatus of a device and method for the three-dimensional detection of acoustic waves and the imaging when detecting a sudden, loud noise, in accordance with an embodiment of the invention;

FIG. 9 is the zoomed-in, delay-added version of the data detected by the acoustic sensor apparatus of a device and method for the three-dimensional detection of acoustic waves and the imaging when detecting a sudden, loud noise, in accordance with an embodiment of the invention;

FIG. 10 is the combined data from four acoustic sensors of a device and method for the three-dimensional detection of acoustic waves and the locating and imaging thereof with the delay added, in accordance with an embodiment of the invention; and

FIG. 11 is a visualization of how the device and method for the three-dimensional detection of acoustic waves and the locating and imaging thereof inputs delays, in accordance with an embodiment of the invention.

### DETAILED DESCRIPTION

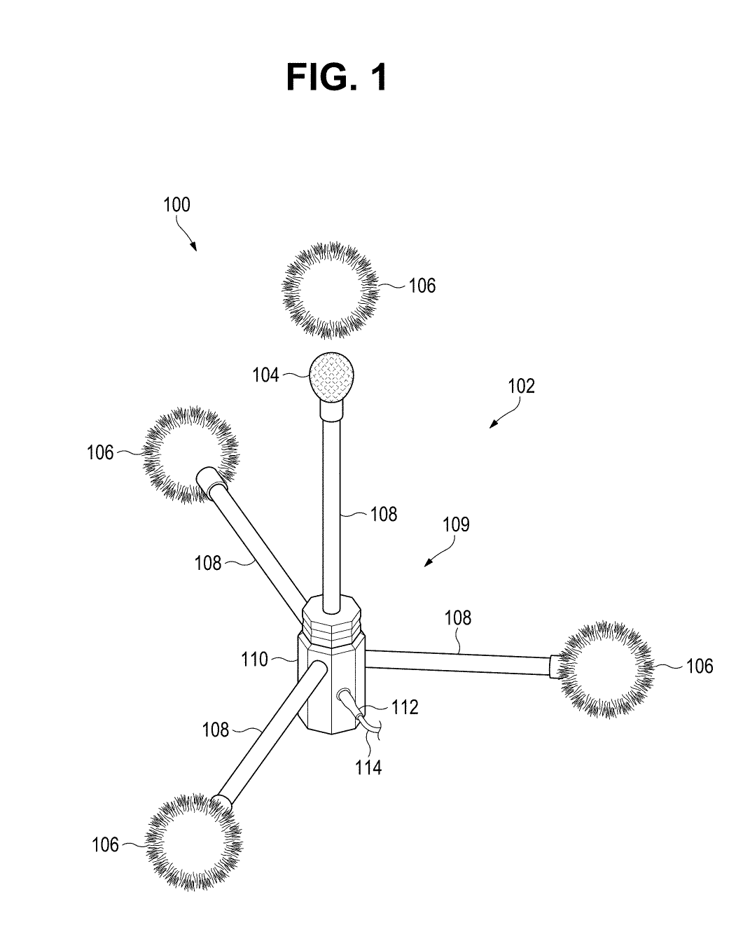

This invention relates generally to a device and method for the three-dimensional detection of acoustic waves and the locating and imaging thereof. Specific details of certain embodiments of the invention are set forth in the following description and in FIGS. 1-11 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a perspective view of an acoustic sensor apparatus component 100 of a device and method for the three-dimensional detection of acoustic waves and the locating and imaging thereof, in accordance with an embodiment of the invention.

In some embodiments, an acoustic sensor apparatus 100 of a device and method for the three-dimensional detection of acoustic waves and the locating and imaging thereof 102 is comprised of one or more acoustic sensors 104 which may be covered in windscreens 106 connected together via pylons 108 meeting at a base 110 wherein each pylon 108 forms the axis of an equilateral tetrahedron 109 with the base 110 at the center. In some embodiments the base 110 may have a connection port 112 that may connect to an antenna or wire 114 to connect to additional equipment.

In one embodiment, a device and method for the three-dimensional detection of acoustic waves and the locating and imaging thereof 102 is comprised of four acoustic sensors 104, with one of the number of acoustic sensors 104 each positioned at each apex of an equilateral tetrahedron 109 with a number of faces equal to the number of acoustic sensors 104 wherein the apexes are at a distance of one and a half feet from the center of the tetrahedron 109.

The sensors 104 may be mounted on pylons 108 or part of a latticework. The pylons 108, when present, may be hollow, solid, or a hybrid of the two. The acoustic sensors 104 may be connected directly to each other by pylons 108 or may be connected to a receiver or base 110 from which the pylons emerge. In some embodiments, the acoustic sensors 104 are mounted on pylons 108 that are one and a half feet from the center of one of the faces. In other embodiments the acoustic sensors 104 are mounted on pylons 108 that are greater than one and a half feet, while in other embodiments the acoustic sensors 104 are mounted on pylons 108 that are shorter than one and a half feet. In some embodiments, the acoustic sensors 104 are not mounted on pylons 108 but are connected by wire 114 or wirelessly to a computer or data gathering device. In some embodiments the acoustic sensors 104 may be positioned far away from the data gathering device 102 such as several miles in order to, for example, detect and triangulate sounds from a long distance.

In some embodiments the device is an equilateral tetrahedron 109, while in other embodiments it may be an equilateral or non-equilateral polyhedron such as a pentahedron or hexahedron. In the case of a pentahedron there would be five or six sensors 104, one at each vertex, depending on the exact shape. In a hexahedron embodiment there would be eight sensors 104, one at each vertex.

This device 102 can be calibrated to attach to a variety of vehicles including, but not limited to, a car, truck, or even helicopter. In situations where the vehicle may be in operation during the use of the device it can be calibrated to compensate for the added noise from the vehicle. In addition, the method of calculation that present device uses assists in maximizing the detected input from the source of the noise and minimizes other ambient noises, even where they may be much higher than a typical day-to-day noise such as in situations including, but not limited to, engine of a car, the music of a concern, or spinning of helicopter blades.

In some embodiments the sensors 104 are acoustic sensors. In some embodiments the sensors 104 may be configured to detect light or other waveforms. In some embodiments, the sensors 104 are protected by windscreens 106, or may be additionally or alternatively protected by pop shields, pop filters or pop screens.

In some embodiments the device 102 includes a base 110 from which the pylons 108 the sensors 104 are mounted upon emerge. The base 110 may be a variety of shapes including but not limited to a cube, cylinder, prism, hexagonal prism, polyhedron, cone, or other polygonal shape. The base 102 may house some or all of any included computational or electronic components including, but not limited to, digital receivers, computer processors, memory, digital-analog converters, signal receivers, wireless data receivers.

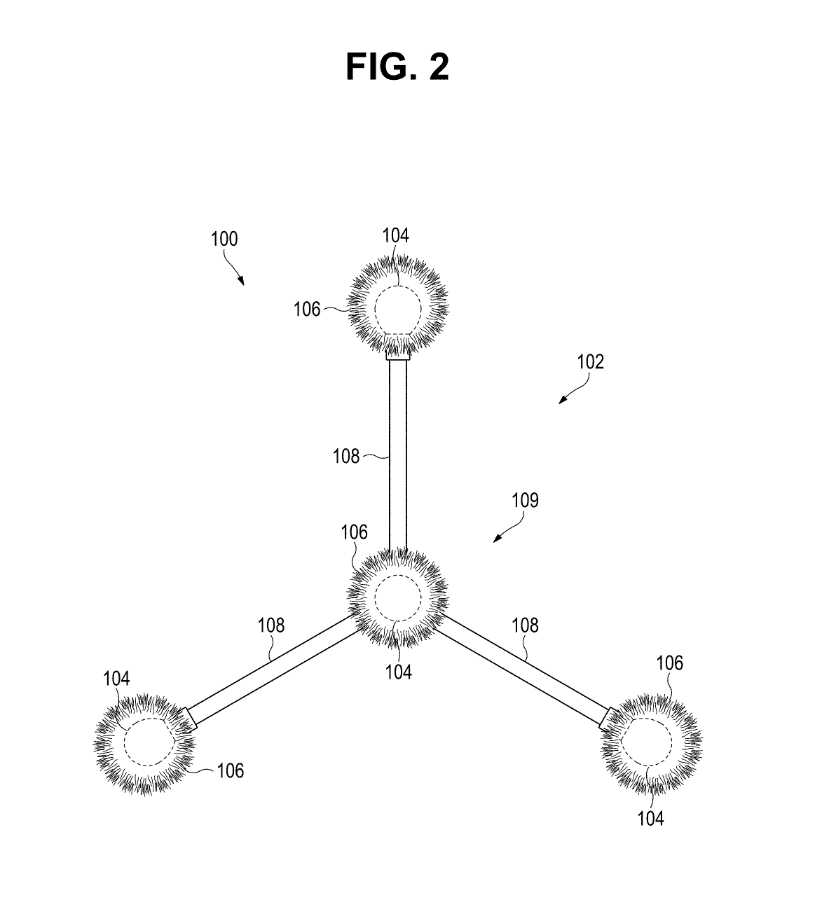

FIG. 2 is a top view of an acoustic sensor apparatus component 100 of a device and method for the three-dimensional detection of acoustic waves and the locating and imaging thereof 102, in accordance with an embodiment of the invention.

In some embodiments, an acoustic sensor apparatus 100 of a device and method for the three-dimensional detection of acoustic waves and the locating and imaging thereof 102 is comprised of one or more acoustic sensors 104 which may be covered in windscreens 106 connected together via pylons 108 meeting at a base wherein each pylon 108 forms the axis of an equilateral tetrahedron 109 with the base at the center. In some embodiments the base may have a connection port 112 that may connect to an antenna or wire 114 to connect to additional equipment.

In one embodiment, a device and method for the three-dimensional detection of acoustic waves and the locating and imaging thereof 102 is comprised of four acoustic sensors 104, with one of the number of acoustic sensors 104 each positioned at each apex of an equilateral tetrahedron 109 with a number of faces equal to the number of acoustic sensors 104 wherein the apexes are at a distance of one and a half feet from the center of the tetrahedron 109.

The acoustic sensors 104 may be mounted on pylons 108 or part of a latticework. The pylons 108, when present, may be hollow, solid, or a hybrid of the two. The acoustic sensors 104 may be connected directly to each other by pylons 108 or may be connected to a receiver or base from which the pylons emerge. In some embodiments, the acoustic sensors 104 are mounted on pylons 108 that are one and a half feet from the center of one of the faces. In other embodiments the acoustic sensors 104 are mounted on pylons 108 that are greater than one and a half feet, while in other embodiments the acoustic sensors 104 are mounted on pylons 108 that are shorter than one and a half feet. In some embodiments, the acoustic sensors 104 are not mounted on pylons 108 but are connected by wire 114 or wirelessly to a computer or data gathering device. In some embodiments the acoustic sensors 104 may be positioned far away from the data gathering device 102 such as several miles in order to detect and triangulate sounds from a long distance.

In some embodiments the device is an equilateral tetrahedron 109, while in other embodiments it may be an equilateral or non-equilateral polyhedron such as a pentahedron or hexahedron. In the case of a pentahedron there would be five or six sensors 104, one at each vertex, depending on the exact shape. In a hexahedron embodiment there would be eight sensors 104, one at each vertex.

This device 102 can be calibrated to attach to a variety of vehicles including, but not limited to, a car, truck, or even helicopter. In situations where the vehicle may be in operation during the use of the device it can be calibrated to compensate for the added noise from the vehicle. In addition, the method of calculation that present device uses assists in maximizing the detected input from the source of the noise and minimizes other ambient noises, even where they may be much higher than a typical day-to-day noise such as in situations including, but not limited to, engine of a car, the music of a concern, or spinning of helicopter blades.

In some embodiments the sensors 104 are acoustic sensors. In some embodiments the sensors 104 may be configured to detect light or other waveforms. In some embodiments, the sensors 104 are protected by windscreens 106, or may be additionally or alternatively protected by pop shields, pop filters or pop screens.

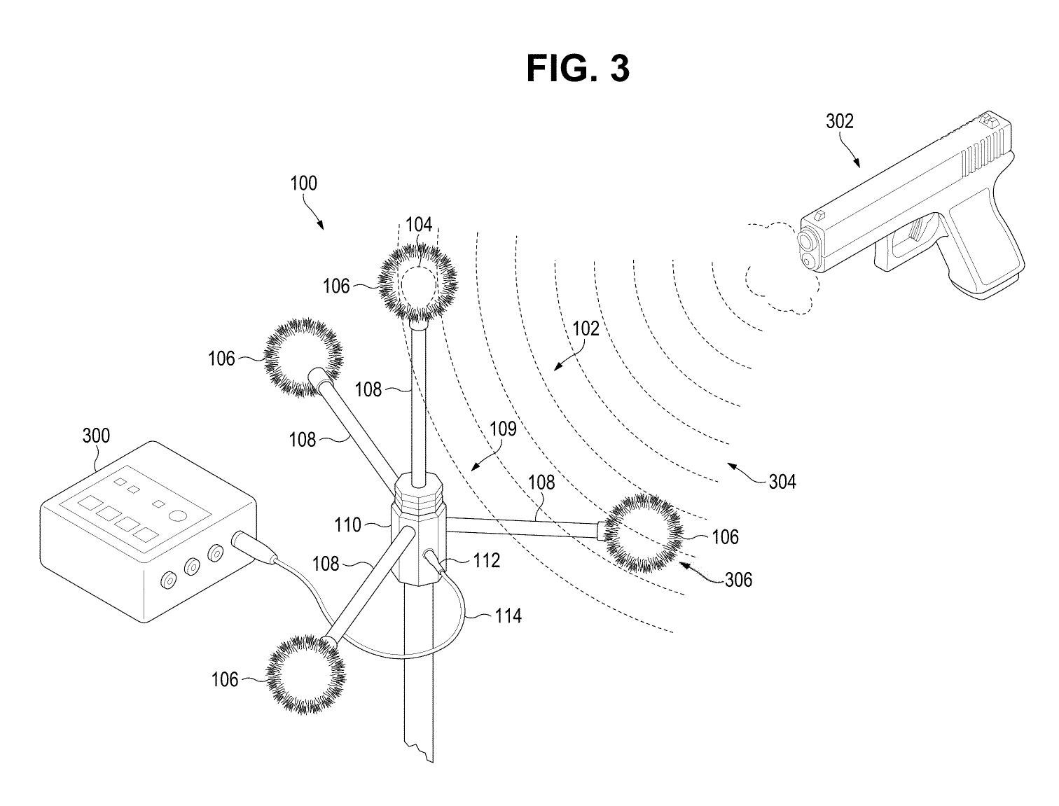

FIG. 3 is a perspective, scene view of an acoustic sensor component 102 of a device 102 and method for the three-dimensional detection of acoustic waves and the locating and imaging thereof 100 in use, in accordance with an embodiment of the invention.

In some embodiments, an acoustic sensor apparatus 100 of a device and method for the three-dimensional detection of acoustic waves and the locating and imaging thereof 102 is comprised of one or more acoustic sensors 104 which may be covered in windscreens 106 connected together via pylons 108 meeting at a base 110 wherein each pylon 108 forms the axis of an equilateral tetrahedron 109 with the base 110 at the center. In some embodiments the base 110 may have a connection port 112 that may connect to an antenna or wire 114 to connect to additional equipment.

In one embodiment, a device and method for the three-dimensional detection of acoustic waves and the locating and imaging thereof 102 is comprised of four acoustic sensors 104, with one of the number of acoustic sensors 104 each positioned at each apex of an equilateral tetrahedron 109 with a number of faces equal to the number of acoustic sensors 104 wherein the apexes are at a distance of one and a half feet from the center of the tetrahedron 109.

The acoustic sensors 104 may be mounted on pylons 108 or part of a latticework. The pylons 108, when present, may be hollow, solid, or a hybrid of the two. The acoustic sensors 104 may be connected directly to each other by pylons 108 or may be connected to a receiver or base 110 from which the pylons emerge. In some embodiments, the acoustic sensors 104 are mounted on pylons 108 that are one and a half feet from the center of one of the faces. In other embodiments the acoustic sensors 104 are mounted on pylons 108 that are greater than one and a half feet, while in other embodiments the acoustic sensors 104 are mounted on pylons 108 that are shorter than one and a half feet. In some embodiments, the acoustic sensors 104 are not mounted on pylons 108 but are connected by wire 114 or wirelessly to a receiver 300 that may be a computer or data gathering device. In some embodiments the acoustic sensors 104 may be positioned far away from the data gathering device 102 such as several miles in order to detect and triangulate sounds from a long distance.

In some embodiments the device is an equilateral tetrahedron 109, while in other embodiments it may be an equilateral or non-equilateral polyhedron such as a pentahedron or hexahedron. In the case of a pentahedron there would be five or six sensors 104, one at each vertex, depending on the exact shape. In a hexahedron embodiment there would be eight sensors 104, one at each vertex.

Depicted in FIG. 3 is an embodiment of the device in use wherein a loud noise 302 is triggered such as, but not limited to, a gunshot or explosion, and the sound waves 304 travel towards the device 102 and are received by the sensors 104 at different times. Hexidrant isolation allows the device 102 to assume the direction of the source 302 because the sound waves 304 will be first detected by sensor 306. The delay with the strongest signal will be one where sensor 306 detects the sound waves 304 first, followed in order of proximity to the source of the loud noise 302. Whichever delay corresponds to that order of proximity will have the highest constructive interference when the waves detected by the sensors 104 are combined.

In some embodiments the sensors 104 are acoustic sensors. In some embodiments the sensors 104 may be configured to detect light or other waveforms. In some embodiments, the sensors 104 are protected by windscreens 106, or may be additionally or alternatively protected by pop shields, pop filters or pop screens.

In some embodiments the device 102 includes a base 110 from which the pylons 108 the sensors 104 are mounted upon emerge. The base 110 may be a variety of shapes including but not limited to a cube, cylinder, prism, hexagonal prism, polyhedron, cone, or other polygonal shape.

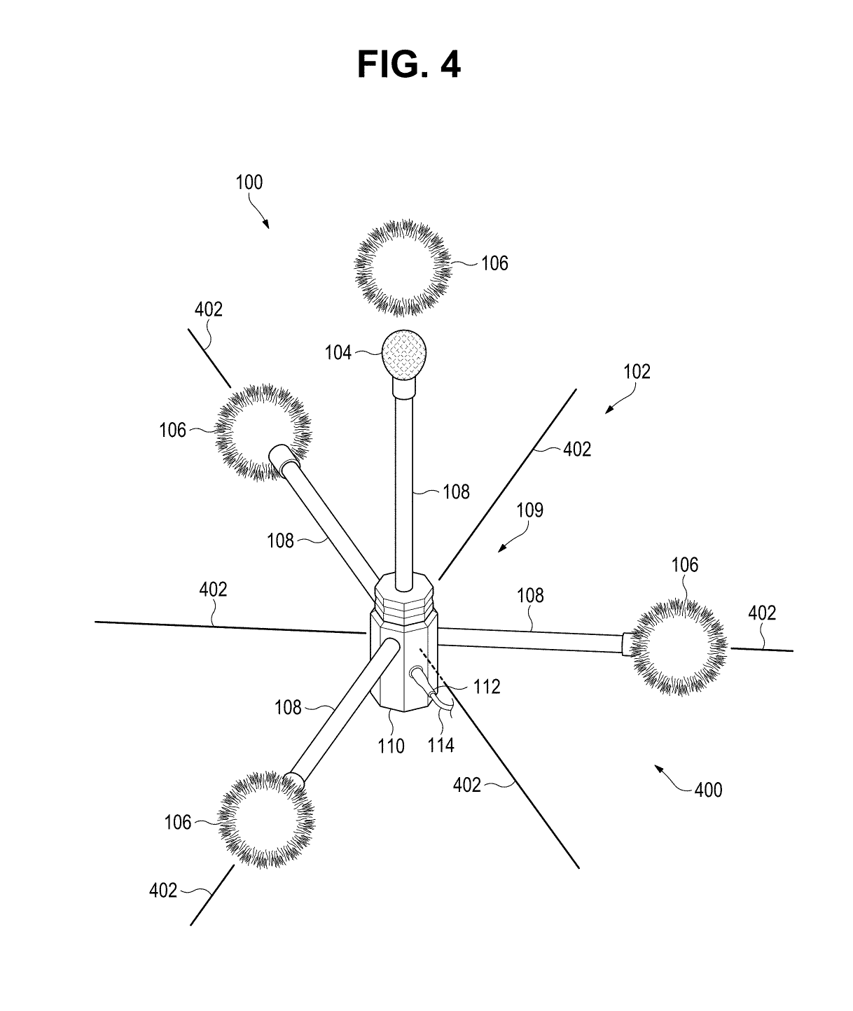

FIG. 4 is a perspective view of an acoustic sensor apparatus component 100 of a device and method for the three-dimensional detection of acoustic waves and the locating and imaging thereof 102 with lines to indicate the division of hexidrants, in accordance with an embodiment of the invention;

In some embodiments, an acoustic sensor apparatus 100 of a device and method for the three-dimensional detection of acoustic waves and the locating and imaging thereof 102 is comprised of one or more acoustic sensors 104 which may be covered in windscreens 106 connected together via pylons 108 meeting at a central base 110 wherein each pylon 108 forms the axis of an equilateral tetrahedron with the base 110 at the center. In some embodiments the base may have a connection port 112 that may connect to an antenna or wire 114 to connect to additional equipment.

In one embodiment, a device and method for the three-dimensional detection of acoustic waves and the locating and imaging thereof 102 is comprised of four acoustic sensors 104, with one of the number of acoustic sensors 104 each positioned at each apex of an equilateral tetrahedron 109 with a number of faces equal to the number of acoustic sensors 104 wherein the apexes are at a distance of one and a half feet from the center of the tetrahedron 109.

The acoustic sensors 104 may be mounted on pylons 108 or part of a latticework. The pylons 108, when present, may be hollow, solid, or a hybrid of the two. The acoustic sensors 104 may be connected directly to each other by pylons 108 or may be connected to a receiver or base 110 from which the pylons emerge. In some embodiments, the acoustic sensors 104 are mounted on pylons 108 that are one and a half feet from the center of one of the faces. In other embodiments the acoustic sensors 104 are mounted on pylons 108 that are greater than one and a half feet, while in other embodiments the acoustic sensors 104 are mounted on pylons 108 that are shorter than one and a half feet. In some embodiments, the acoustic sensors 104 are not mounted on pylons 108 but are connected by wire 114 or wirelessly to a receiver 300 that may be a computer or data gathering device. In some embodiments the acoustic sensors 104 may be positioned far away from the data gathering device 102 such as several miles in order to detect and triangulate sounds from a long distance.

In some embodiments the device is an equilateral tetrahedron 109, while in other embodiments it may be an equilateral or non-equilateral polyhedron such as a pentahedron or hexahedron. In the case of a pentahedron there would be five or six sensors 104, one at each vertex, depending on the exact shape. In a hexahedron embodiment there would be eight sensors 104, one at each vertex.

This device 102 can be calibrated to attach to a variety of vehicles including, but not limited to, a car, truck, or even helicopter. In situations where the vehicle may be in operation during the use of the device it can be calibrated to compensate for the added noise from the vehicle. In addition, the method of calculation that present device uses assists in maximizing the detected input from the source of the noise and minimizes other ambient noises, even where they may be much higher than a typical day-to-day noise such as in situations including, but not limited to, engine of a car, the music of a concern, or spinning of helicopter blades.

In some embodiments the sensors are acoustic sensors. In some embodiments the sensors 104 may be configured to detect light or other waveforms. In some embodiments, the sensors 104 are protected by windscreens 106, or may be additionally or alternatively protected by pop shields, pop filters or pop screens.

In some embodiments the device 102 includes a base 110 from which the pylons 108 the sensors 104 are mounted upon emerge. The base 110 may be a variety of shapes including but not limited to a cube, cylinder, prism, hexagonal prism, polyhedron, cone, or other polygonal shape.

In some embodiments, the location computation splits the x-y plane into six hexidrants 400 with three of the seven axes 402 emerging from the center and passing through the location of each of the horizontal three sensors 104 along the x-y plane, and the other three emerge halfway between each pair of sensors 104. The final sensor 404 emerges from the z axis, perpendicular to the x-y plane. The axes between the sensors 104 may be referred to as ideals because any incoming wave would be detected by the sensors 104 the axes 402 is located between at the same time. In effect, splitting the area around the three lower sensors into hexidrants 400 allows the system to assume the basic direction from which a sound came based on which sensor 104 detects it first. The first sensor 104 to detect a sound thus means the sound came from one of the two hexidrants 400 on either side of that sensor 104. The determination can be further honed by then determining when the other two horizontally aligned sensors 104 detected the sound. If, relative to the sensor 104 that detected the sound first, the one rightwards of it detects the sound second, then it can be presumed that the sound is coming from the right-side hexidrant 400 relative to the first sensor 104.

Therefore, the same assumptive reasoning can be applied to the top sensor 404; a sound that is detected by a horizontal plane sensor 104 will be detected first by a horizontal plane sensor 104 unless the sound originates from above forty-five degrees over the device, in which case it will be detected by the top sensor 404 before any of the horizontal sensors 104. In such cases the system can assume the sound is emanating from somewhere in the inverted cone with a forty-five degree slope originating out of the base 110 of the device. Once that assumption is made the system can compute the relative direction based on when the other three sensors 104 detect the sound.

In some embodiments, there are additional sensors 100 and the computation splits the x-y plan, or another similar plane, into more or fewer segments based on the number and positioning of the sensors 100.

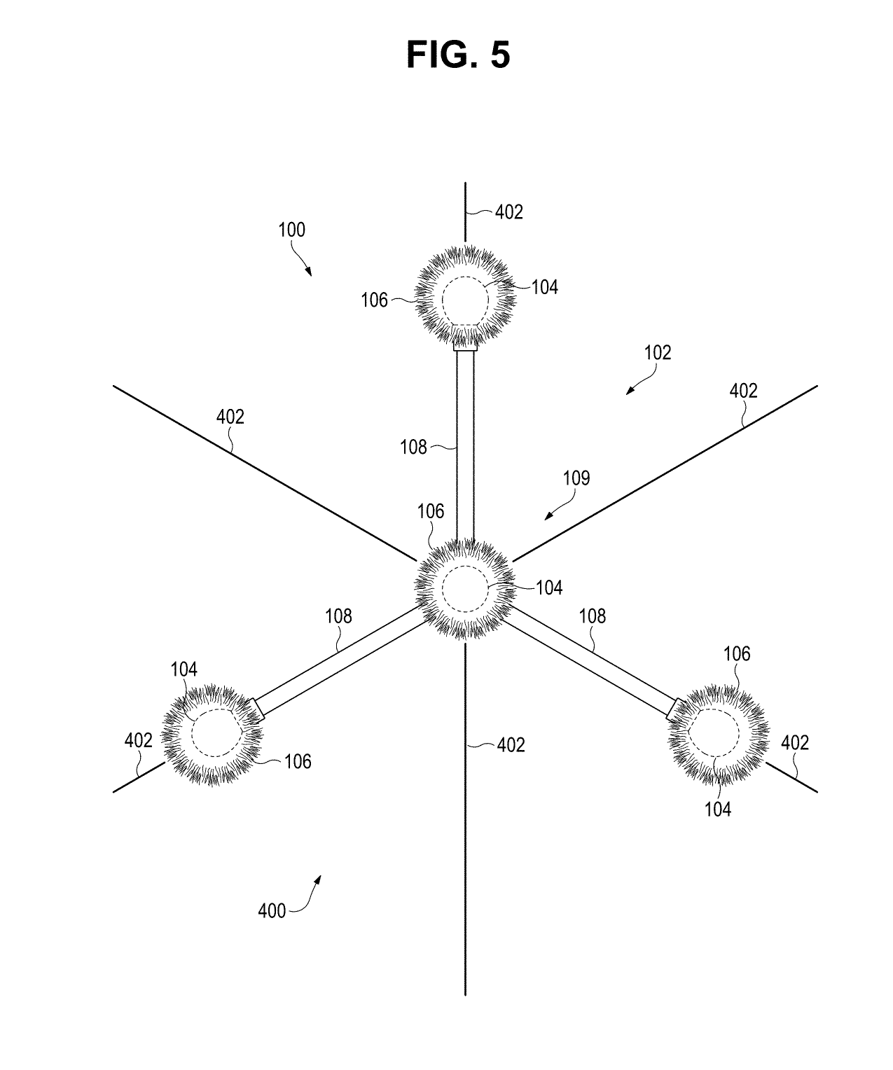

FIG. 5 is a top view of an acoustic sensor apparatus component 100 of a device and method for the three-dimensional detection of acoustic waves and the locating and imaging thereof 102 with lines to indicate the division of hexidrants, in accordance with an embodiment of the invention.

In some embodiments, an acoustic sensor apparatus 100 of a device and method for the three-dimensional detection of acoustic waves and the locating and imaging thereof 102 is comprised of one or more acoustic sensors 104 which may be covered in windscreens 106 connected together via pylons 108 meeting at a central base wherein each pylon 108 forms the axis of an equilateral tetrahedron with the base at the center. In some embodiments the base may have a connection port 112 that may connect to an antenna or wire 114 to connect to additional equipment.

In one embodiment, a device and method for the three-dimensional detection of acoustic waves and the locating and imaging thereof 102 is comprised of four acoustic sensors 104, with one of the number of acoustic sensors 104 each positioned at each apex of an equilateral tetrahedron 109 with a number of faces equal to the number of acoustic sensors 104 wherein the apexes are at a distance of one and a half feet from the center of the tetrahedron 109.

The acoustic sensors 104 may be mounted on pylons 108 or part of a latticework. The pylons 108, when present, may be hollow, solid, or a hybrid of the two. The acoustic sensors 104 may be connected directly to each other by pylons 108 or may be connected to a receiver or base from which the pylons emerge. In some embodiments, the acoustic sensors 104 are mounted on pylons 108 that are one and a half feet from the center of one of the faces. In other embodiments the acoustic sensors 104 are mounted on pylons 108 that are greater than one and a half feet, while in other embodiments the acoustic sensors 104 are mounted on pylons 108 that are shorter than one and a half feet. In some embodiments, the acoustic sensors 104 are not mounted on pylons 108 but are connected by wire 114 or wirelessly to a receiver 300 that may be a computer or data gathering device. In some embodiments the acoustic sensors 104 may be positioned far away from the data gathering device 102 such as several miles in order to detect and triangulate sounds from a long distance.

In some embodiments the device is an equilateral tetrahedron 109, while in other embodiments it may be an equilateral or non-equilateral polyhedron such as a pentahedron or hexahedron. In the case of a pentahedron there would be five or six sensors 104, one at each vertex, depending on the exact shape. In a hexahedron embodiment there would be eight sensors 104, one at each vertex.

This device 102 can be calibrated to attach to a variety of vehicles including, but not limited to, a car, truck, or even helicopter. In situations where the vehicle may be in operation during the use of the device it can be calibrated to compensate for the added noise from the vehicle. In addition, the method of calculation that present device uses assists in maximizing the detected input from the source of the noise and minimizes other ambient noises, even where they may be much higher than a typical day-to-day noise such as in situations including, but not limited to, engine of a car, the music of a concern, or spinning of helicopter blades.

In some embodiments the sensors are acoustic sensors. In some embodiments the sensors 104 may be configured to detect light or other waveforms. In some embodiments, the sensors 104 are protected by windscreens 106, or may be additionally or alternatively protected by pop shields, pop filters or pop screens.

In some embodiments the device includes a base from which the pylons 108 the sensors 104 are mounted upon emerge. The base may be a variety of shapes including but not limited to a cube, cylinder, prism, hexagonal prism, polyhedron, cone, or other polygonal shape.

In some embodiments, the location computation splits the x-y plane into six hexidrants 400 with three of the seven axes 402 emerging from the center and passing through the location of each of the horizontal three sensors 104 along the x-y plane, and the other three emerge halfway between each pair of sensors 104. The final sensor 404 emerges from the z axis, perpendicular to the x-y plane. The axes between the sensors 104 may be referred to as ideals because any incoming wave would be detected by the sensors 104 the axes 402 is located between at the same time. In effect, splitting the area around the three lower sensors into hexidrants 400 allows the system to assume the basic direction from which a sound came based on which sensor 104 detects it first. The first sensor 104 to detect a sound thus means the sound came from one of the two hexidrants 400 on either side of that sensor 104. The determination can be further honed by then determining when the other two horizontally aligned sensors 104 detected the sound. If, relative to the sensor 104 that detected the sound first, the one rightwards of it detects the sound second, then it can be presumed that the sound is coming from the right-side hexidrant 400 relative to the first sensor 104.

Therefore, the same assumptive reasoning can be applied to the top sensor 404; a sound that is detected by a horizontal plane sensor 104 will be detected first by a horizontal plane sensor 104 unless the sound originates from above forty-five degrees over the device, in which case it will be detected by the top sensor 404 before any of the horizontal sensors 104. In such cases the system can assume the sound is emanating from somewhere in the inverted cone with a forty-five degree slope originating out of the base of the device. Once that assumption is made the system can compute the relative direction based on when the other three sensors 104 detect the sound.

In some embodiments, there are additional sensors 100 and the computation splits the x-y plan, or another similar plane, into more or fewer segments based on the number and positioning of the sensors 100.

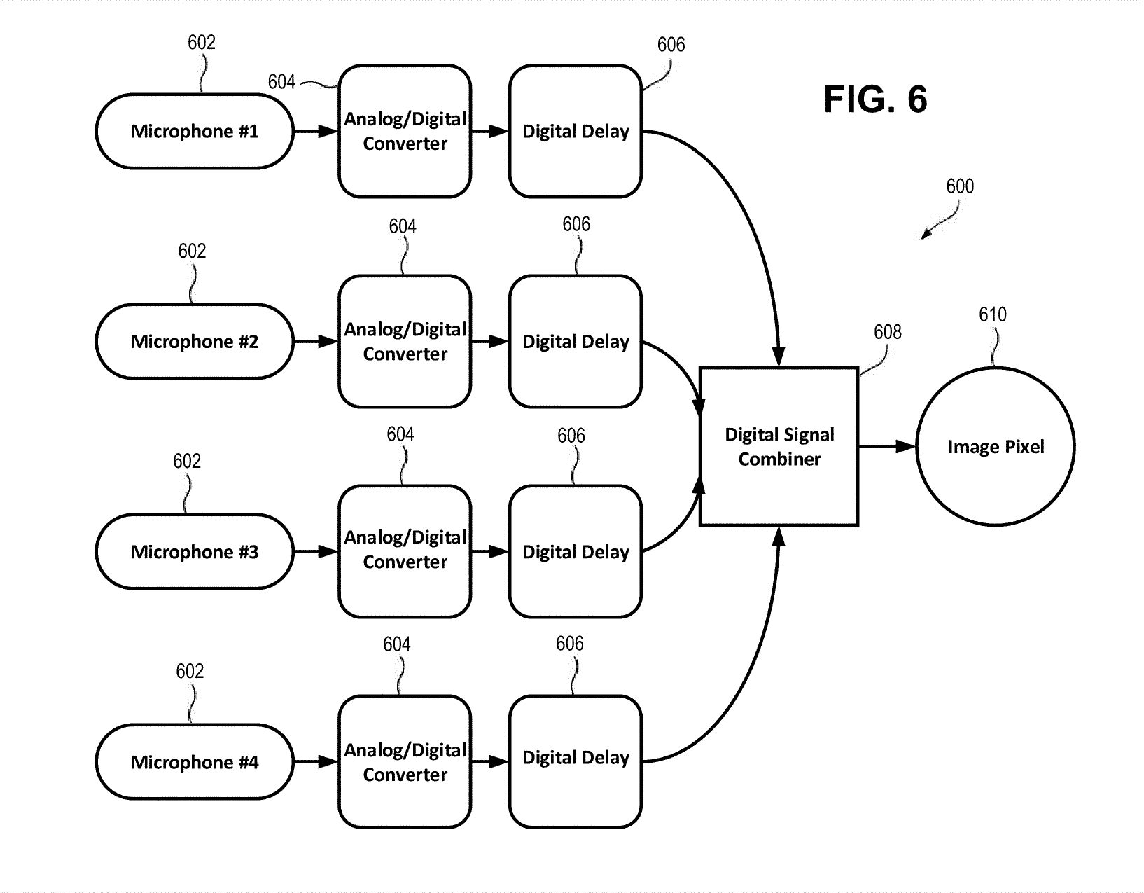

FIG. 6 is a flow-chart 600 demonstrating the process showing the detection of input by a sensor to the mapping utilizing the digital delays to a single pixel, in accordance with an embodiment of the invention.

In some embodiments the sound map is created by first taking in the input received by each sensor 602, if necessary converting the data from analog to digital if the sensor requires it 604, adding the pre-set delay to the data from each sensor based on which final sound map pixel is desired 606, combining the signals received by the sensors into a single signal 608, and taking the known information of where relative to the sensors the chosen delay would map sound to and plotting the intensity of the combined signals at that pixel 610.

By repeating the above process, and applying a different delay 606 associated with a different predicted location in the imaginary sphere around the sensors to the same sets of received sensor data 602, the system can plot a three-dimensional map on the imaginary sphere of space surrounding the device by plotting the intensity for each delay.

In some embodiments, the present invention improves on conventional methods of acoustic detection which measure the time difference of arrival times (“TDOA”) of sound waves at certain acoustic sensors. In its simplest form the TDOA determines sound origination locations by measuring Δt, delta t, the time difference in seconds between when two sensors detect the sound, which is calculated by taking the distance between the two sensors, multiplied by the cosine of the baseline angle between them and the incident sound, over the speed of sound. Combining the known factors, a user can solve the equation for the cosine of the baseline angle, and from there find the baseline angle. In the present method, the speed of sound may be assumed given ordinary terrestrial circumstances, though can be modified based on the medium in the location being monitored or based on data detected by sensors, and an artificial delay is input into the data of the first and all but the last microphones to detect a sound so that the waveforms are constructively added to the original waveform to assist in distilling the incident noise from the surrounding noise.

This system and method combines some of the theory behind TDOA with triangulation principles given that the location of the sensors relative to each other is a known quantity and the speed of sound in a given medium is also known. In one embodiment, the system and method involve inverting part of the traditional TDOA calculation; instead of having a pre-programmed value for the speed of sound and comparing the exact time sounds were received directly, the system utilizes a number of pre-programmed delays that, when combined, correspond to the entire field representing an imaginary sphere around the device. The device then, rather than having to wait for each acoustic sensor to detect a sound and then work backwards from there, applies its modifications and delay to the data it receives from the acoustic sensors to be able to listen to multiple locations at the same time. In some embodiments the system is configured with a number of different delays, each correlated with a direction a sound could be coming from, and when sound is detected the system applies each delay to the sound. Since each delay correlates to a different direction, the direction and intensity of the sound are mapped. In other words, the delays essentially fill in assumed values

In the present invention, rather than relying solely on algorithmic solutions to determine locations, the system compares the amount of constructive interference created when mixing and combining signals together using preset delays. The system can then be supported by utilizing TDOA and/or triangulation principles to improve accuracy and reliability, but it is not required the system do so.

In some embodiments, the calibration configuration can be modified to account for variations in the medium such as, pressure, humidity or temperature as applicable. In some embodiments, the device may be further comprised of one or more temperature sensors which enable the device to predict the necessary delays based on the variations in the local speed of sound. In some embodiments, the device can be calibrated for use in other sound conducting media including underwater, inside solids, or otherwise gases or liquids besides typical Earth atmosphere.

By adding different delays, the system can be configured to listen to certain locations. This may be achieved by pre-inputting delays, or partially pre-inputting delays. For example, to create a delay to have the system listen to a location that is in-line with one of the acoustic sensors and at level with it, the delay would be calculated such that it is assumed the sound reaches the acoustic sensor in line with it first, then the other two lower sensors second simultaneously, and the top sensor last; because the speed of sound is known or can be accurately assumed, the delay can be derived from that. The next delay for a location slightly aside from that one would be input with the presumption that the sound arrives slightly later to the first sensor, to one of the side sensors slightly earlier and the other later, and to the top sensor later still depending on how far to the side the delay is being calculated. In some embodiments the system can be pre-programmed with the current constants for the speed of sound based on factors including, but not limited to, temperature and atmospheric pressure, or the system can include sensors capable of detecting such factors and internally adjusting the delays.

Thus, the system can be configured with a large range of delays so that it is able to generate a sound-intensity map of a three-dimensional area by breaking the area into a three-dimensional with three or more axes. The system would not be required to actively move the acoustic sensors but instead would be able to view a range of locations by adding different delays to the data collected by the acoustic sensors and using that as its targeting mechanism. In practice, the system functions thusly: a three-dimensional area around the system can be generalized as a sphere divided into a grid; a sound incoming from a specific sector on the grid and be listened to by utilizing a pre-set delay; and by then creating a delay for each sector on the grid—by having the delay for each location pre-calculated as if the sound had come from that location—the device can create a three-dimensional map of the local area around itself. Combined with proper display software the device can also create three-dimensional maps with certain sounds sources marked as “hot spots” on a form of heat-map of the local area which can be displayed relative to line-of-sight to the device and/or as a generalized map.

In some embodiments, the device can be combined with software and hardware solutions to isolate certain frequencies and allow for frequency specific delays to reduce error created due to artifacts from resonant frequencies. When searching for specific frequencies the device can be calibrated further to account for the frequency in question, adding a known delay based on the anticipated wavelength and arrival time of the frequency. Alternatively, the device can be configured to only listen for specified frequencies and/or wavelengths, or to look for them specifically in the data to pick them

When isolating based on frequency in addition to arrival time the present device is thus capable of creating a sound map that shows the relative strengths of sounds based on audio frequency bands for a given area. In some embodiments, the system may be configured to display the audio frequency strengths in various colors or other means of indicating the strengths of differing sounds. In such embodiments brightness may be associated with the signal strength of the signal after the signals have been combined.

In some embodiments, the system can be configured to ignore certain delays or ranges, thereby saving on processing power and improving overall speed and efficiency of the detection system to allow for a more rapid location. For example, were a user only concerned with sounds emanating from a certain range, such as the 180-degree semi-sphere presently in front of them, the system could be configured to input only delays that would result in sounds from that direction; essentially not triggering on acoustic sounds that are not first detected by the one or more acoustic detectors pointed in that direction.

The delay mixing component of the system can also enable the system to pick specific noises out of an otherwise high level of disruptive background noise. In some embodiments the system applies the delay to the input data received by each sensor and thus the delays allow the waveforms of the sudden, louder noise to constructively interfere, thus making them stand out over varying background noise which will usually not reach the same peak as the noise being listened for.

In some embodiments the system can be configured to reduce processing demand by taking the data from all the acoustic sensors, adding a pre-set delay to the data from each sensor, combining the delay-added datasets into single waveforms representing constructive interference from each dataset, reviewing each dataset to determine which has the highest recorded input value—in some embodiments this input may be in decibels—, determine which delay was added to the dataset with the highest recorded input value, determine which location that delay was programmed to orient towards, and then set the pixel associated with that location as the brightest. Then the system can look at the pixels around the highest and set their brightness lower but relative to the first pixel until the system reaches the lowest recorded input levels, which would be the darkest pixels.

In some embodiments, the acoustic location computation splits the x-y plane into six hexidrants with three of the seven axes emerging from the center and passing through the location of each of the three sensors, and the other three emerge halfway between each pair of sensors. The final sensor emerges from the z axis, perpendicular to the x-y plane. The axes between the sensors may be referred to as ideals because any incoming wave would be detected by the sensors the axes is located between at the same time. In effect, splitting the area around the three lower sensors into hexidrants allows the system to assume the basic direction from which a sound came based on which sensor detects it first. The first sensor to detect a sound thus means the sound came from one of the two hexidrants on either side of that sensor 104. The determination can be further honed by then determining when the other two horizontally aligned sensors detected the sound. If, relative to the sensor that detected the sound first, the one rightwards of it detects the sound second, then it can be presumed that the sound is coming from the right-side hexidrant relative to the first sensor.

Therefore, the same assumptive reasoning can be applied to the top sensor; a sound that is detected by a horizontal plane sensor will be detected first by a horizontal plane sensor unless the sound originates from above forty-five degrees over the device, in which case it will be detected by the top sensor before any of the horizontal sensors. In such cases the system can assume the sound is emanating from somewhere in the inverted cone with a forty-five degree slope originating out of the base of the device. Once that assumption is made the system can compute the relative direction based on when the other three sensors detect the sound.

In some embodiments, there are additional sensors and the computation splits the x-y plan, or another similar plane, into more segments based on the number and positioning of the sensors.

In some embodiments, an attached computer processor receives data on the received sounds from the acoustic sensors, and then plots the waveforms of that data to calculate which sensor detected the waveform first, and then calculates the location of the incoming sounds by comparing the times that the other sensors detected the sound to determine its direction based on the known speed of sound.

In some embodiments, an attached computer processor modifies the incoming sound data by inputting an artificial delay on the first three acoustic sensor waveforms and then combines the resulting waveform, allowing the device to amplify the incoming sound to better detect it from the noise of other incoming sounds. In some embodiments, an attached computer processor could take in data from multiple sounds and combine matching waveforms to generate an image of the surrounding sounds.

In some embodiments, the device includes a computer database and processor configured to compare the waveform of detected acoustic waves to a known library of acoustic waves to determine the cause of the acoustic wave. For example, the database may include the report of various firearms, and would be able to display for a user that a detected acoustic wave was likely the sound of a firearm discharging. In some embodiments, the device may include a display screen to provide information to a user.

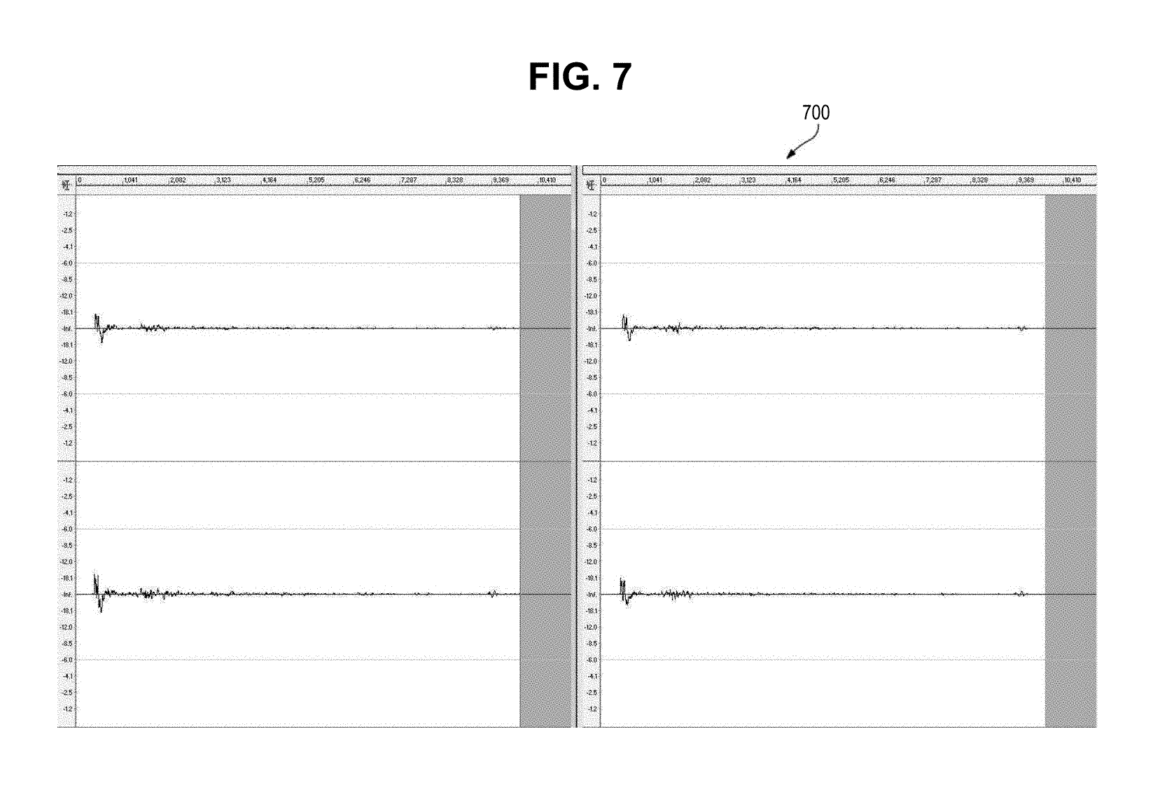

FIG. 7 is the data 700 detected by the acoustic sensor apparatus of a device and method for the three-dimensional detection of acoustic waves and the locating and imaging thereof when detecting a sudden, loud noise, in accordance with an embodiment of the invention.

In some embodiments, the present invention improves on conventional methods of acoustic detection which measure the time difference of arrival times (“TDOA”) of sound waves at certain acoustic sensors. In its simplest form the TDOA determines sound origination locations by measuring Δt, delta t, the time difference in seconds between when two sensors detect the sound, which is calculated by taking the distance between the two sensors, multiplied by the cosine of the baseline angle between them and the incident sound, over the speed of sound. Combining the known factors, a user can solve the equation for the cosine of the baseline angle, and from there find the baseline angle. In the present method, the speed of sound may be assumed given ordinary terrestrial circumstances, though can be modified based on the medium in the location being monitored or based on data detected by sensors, and an artificial delay is input into the data of the first and all but the last microphones to detect a sound so that the waveforms are constructively added to the original waveform to assist in distilling the incident noise from the surrounding noise.

This system and method combines some of the theory behind TDOA with triangulation principles given that the location of the sensors relative to each other is a known quantity and the speed of sound in a given medium is also known. In one embodiment, the system and method involve inverting part of the traditional TDOA calculation; instead of having a pre-programmed value for the speed of sound and comparing the exact time sounds were received directly, the system utilizes a number of pre-programmed delays that, when combined, correspond to the entire field around the device. The device then, rather than having to wait for each acoustic sensor to detect a sound and then work backwards from there, applies its modifications and delay to the data it receives from the acoustic sensors to be able to listen to multiple locations at the same time. In some embodiments the system is configured with a number of different delays, each correlated with a direction a sound could be coming from, and when sound is detected the system applies each delay to the sound. Since each delay correlates to a different direction, the direction and intensity of the sound are mapped.

In the present invention, rather than relying solely on algorithmic solutions to determine locations, the system compares the amount of constructive interference created when mixing and combining signals together using preset delays. The system can then be supported by utilizing TDOA and/or triangulation principles to improve accuracy and reliability, but it is not required the system do so.

In some embodiments, the calibration configuration can be modified to account for variations in the medium such as, pressure, humidity or temperature as applicable. In some embodiments, the device may be further comprised of one or more temperature sensors which enable the device to predict the necessary delays based on the variations in the local speed of sound. In some embodiments, the device can be calibrated for use in other sound conducting media including underwater, inside solids, or otherwise gases or liquids besides typical Earth atmosphere.

By adding different delays, the system can be configured to listen to certain locations. This may be achieved by pre-inputting delays, or partially pre-inputting delays. For example, to create a delay to have the system listen to a location that is in-line with one of the acoustic sensors and at level with it, the delay would be calculated such that it is assumed the sound reaches the acoustic sensor in line with it first, then the other two lower sensors second simultaneously, and the top sensor last; because the speed of sound is known or can be accurately assumed, the delay can be derived from that. The next delay for a location slightly aside from that one would be input with the presumption that the sound arrives slightly later to the first sensor, to one of the side sensors slightly earlier and the other later, and to the top sensor later still depending on how far to the side the delay is being calculated. In some embodiments the system can be pre-programmed with the current constants for the speed of sound based on factors including, but not limited to, temperature and atmospheric pressure, or the system can include sensors capable of detecting such factors and internally adjusting the delays.

The delays utilized in the present invention could be conceived as a reversal of the traditional acoustic location calculation, wherein rather than utilizing the delay between each sensor to triangulate the location of the sound, the delays, pre-programmed as one or more sets, are already configured to look at various locations as if sound had come from them, so that instead the device can optionally focus on comparing and calculating the highest recorded intensities by combining the amplitudes of the waveforms after applying the delay to each data set, then comparing which delay set produced the largest amplitude waveform.

Thus, the system can be configured with a large range of delays so that it is able to generate a sound-intensity map of a three-dimensional area by breaking the area into a three-dimensional with three or more axes. The system would not be required to actively move the acoustic sensors but instead would be able to view a range of locations by adding different delays to the data collected by the acoustic sensors and using that as its targeting mechanism. In practice, the system functions thusly: a three-dimensional area around the system can be generalized as a sphere divided into a grid; a sound incoming from a specific sector on the grid and be listened to by utilizing a pre-set delay; and by then creating a delay for each sector on the grid—by having the delay for each location pre-calculated as if the sound had come from that location—the device can create a three-dimensional map of the local area around itself. Combined with proper display software the device can also create three-dimensional maps with certain sounds sources marked as “hot spots” on a form of heat-map of the local area which can be displayed relative to line-of-sight to the device and/or as a generalized map.

In some embodiments, the device can be combined with software and hardware solutions to isolate certain frequencies and allow for frequency specific delays to reduce error created due to artifacts from resonant frequencies. When searching for specific frequencies the device can be calibrated further to account for the frequency in question, adding a known delay based on the anticipated wavelength and arrival time of the frequency. Alternatively, the device can be configured to only listen for specified frequencies and/or wavelengths, or to look for them specifically in the data to pick them

When isolating based on frequency in addition to arrival time the present device is thus capable of creating a sound map that shows the relative strengths of sounds based on audio frequency bands for a given area. In some embodiments, the system may be configured to display the audio frequency strengths in various colors or other means of indicating the strengths of differing sounds. In such embodiments brightness may be associated with the signal strength of the signal after the signals have been combined.

In some embodiments, the system can be configured to ignore certain delays or ranges, thereby saving on processing power and improving overall speed and efficiency of the detection system to allow for a more rapid location. For example, were a user only concerned with sounds emanating from a certain range, such as the 180-degree semi-sphere presently in front of them, the system could be configured to input only delays that would result in sounds from that direction; essentially not triggering on acoustic sounds that are not first detected by the one or more acoustic detectors pointed in that direction.

The delay mixing component of the system can also enable the system to pick specific noises out of an otherwise high level of disruptive background noise. In some embodiments the system applies the delay to the input data received by each sensor and thus the delays allow the waveforms of the sudden, louder noise to constructively interfere, thus making them stand out over varying background noise which will usually not reach the same peak as the noise being listened for.

In some embodiments the system can be configured to reduce processing demand by taking the data from all the acoustic sensors, adding a pre-set delay to the data from each sensor, combining the delay-added datasets into single waveforms representing constructive interference from each dataset, reviewing each dataset to determine which has the highest recorded input value—in some embodiments this input may be in decibels—, determine which delay was added to the dataset with the highest recorded input value, determine which location that delay was programmed to orient towards, and then set the pixel associated with that location as the brightest. Then the system can look at the pixels around the highest and set their brightness lower but relative to the first pixel until the system reaches the lowest recorded input levels, which would be the darkest pixels.

In some embodiments, the acoustic location computation splits the x-y plane into six hexidrants with three of the seven axes emerging from the center and passing through the location of each of the three sensors, and the other three emerge halfway between each pair of sensors. The final sensor emerges from the z axis, perpendicular to the x-y plane. The axes between the sensors may be referred to as ideals because any incoming wave would be detected by the sensors the axes is located between at the same time. In effect, splitting the area around the three lower sensors into hexidrants allows the system to assume the basic direction from which a sound came based on which sensor detects it first. The first sensor to detect a sound thus means the sound came from one of the two hexidrants on either side of that sensor 104. The determination can be further honed by then determining when the other two horizontally aligned sensors detected the sound. If, relative to the sensor that detected the sound first, the one rightwards of it detects the sound second, then it can be presumed that the sound is coming from the right-side hexidrant relative to the first sensor.

Therefore, the same assumptive reasoning can be applied to the top sensor; a sound that is detected by a horizontal plane sensor will be detected first by a horizontal plane sensor unless the sound originates from above forty-five degrees over the device, in which case it will be detected by the top sensor before any of the horizontal sensors. In such cases the system can assume the sound is emanating from somewhere in the inverted cone with a forty-five degree slope originating out of the base of the device. Once that assumption is made the system can compute the relative direction based on when the other three sensors detect the sound.

In some embodiments, there are additional sensors and the computation splits the x-y plan, or another similar plane, into more segments based on the number and positioning of the sensors.

In some embodiments, an attached computer processor receives data on the received sounds from the acoustic sensors, and then plots the waveforms of that data to calculate which sensor detected the waveform first, and then calculates the location of the incoming sounds by comparing the times that the other sensors detected the sound to determine its direction based on the known speed of sound.

In some embodiments, an attached computer processor modifies the incoming sound data by inputting an artificial delay on the first three acoustic sensor waveforms and then combines the resulting waveform, allowing the device to amplify the incoming sound to better detect it from the noise of other incoming sounds. In some embodiments, an attached computer processor could take in data from multiple sounds and combine matching waveforms to generate an image of the surrounding sounds.

In some embodiments, the device includes a computer database and processor configured to compare the waveform of detected acoustic waves to a known library of acoustic waves to determine the cause of the acoustic wave. For example, the database may include the report of various firearms, and would be able to display for a user that a detected acoustic wave was likely the sound of a firearm discharging. In some embodiments, the device may include a display screen to provide information to a user.

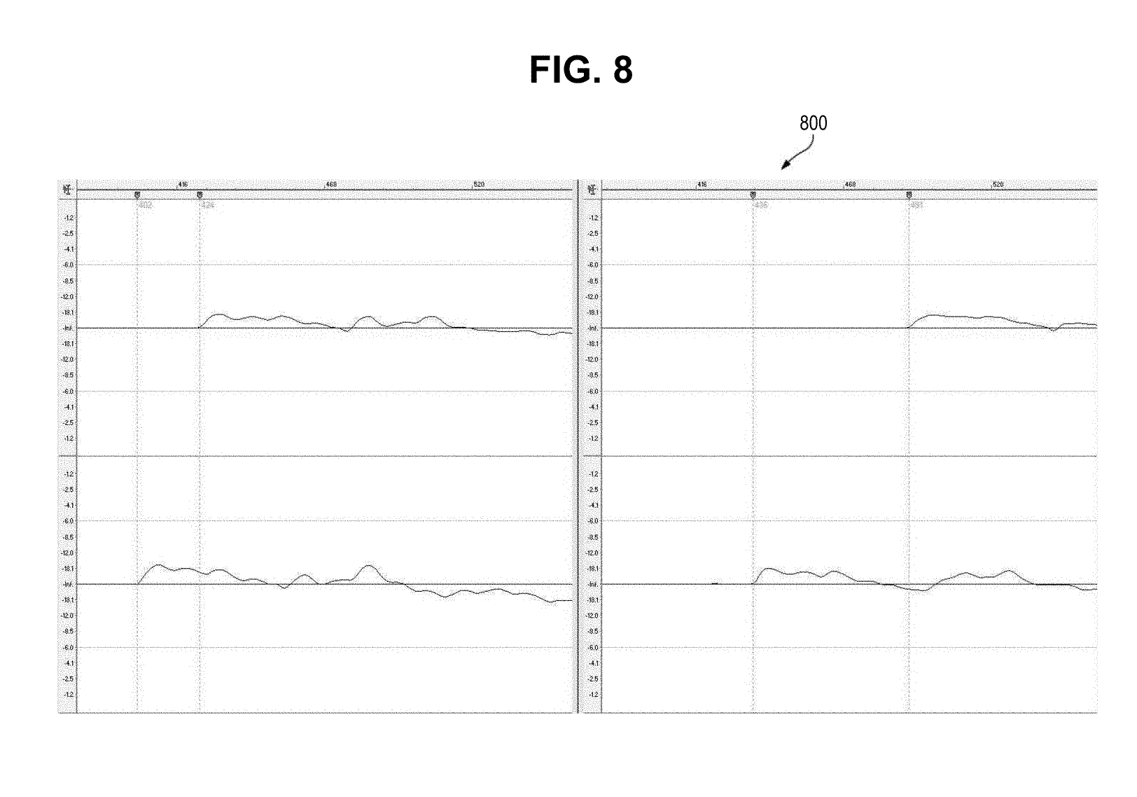

FIG. 8 is the zoomed-in version of the data 800 detected by the acoustic sensor apparatus of a device and method for the three-dimensional detection of acoustic waves and the imaging when detecting a sudden, loud noise, in accordance with an embodiment of the invention.

In some embodiments, the present invention improves on conventional methods of acoustic detection which measure the time difference of arrival times (“TDOA”) of sound waves at certain acoustic sensors. In its simplest form the TDOA determines sound origination locations by measuring Δt, delta t, the time difference in seconds between when two sensors detect the sound, which is calculated by taking the distance between the two sensors, multiplied by the cosine of the baseline angle between them and the incident sound, over the speed of sound. Combining the known factors, a user can solve the equation for the cosine of the baseline angle, and from there find the baseline angle. In the present method, the speed of sound may be assumed given ordinary terrestrial circumstances, though can be modified based on the medium in the location being monitored or based on data detected by sensors, and an artificial delay is input into the data of the first and all but the last microphones to detect a sound so that the waveforms are constructively added to the original waveform to assist in distilling the incident noise from the surrounding noise.

This system and method combines some of the theory behind TDOA with triangulation principles given that the location of the sensors relative to each other is a known quantity and the speed of sound in a given medium is also known. In one embodiment, the system and method involve inverting part of the traditional TDOA calculation; instead of having a pre-programmed value for the speed of sound and comparing the exact time sounds were received directly, the system utilizes a number of pre-programmed delays that, when combined, correspond to the entire field around the device. The device then, rather than having to wait for each acoustic sensor to detect a sound and then work backwards from there, applies its modifications and delay to the data it receives from the acoustic sensors to be able to listen to multiple locations at the same time. In some embodiments the system is configured with a number of different delays, each correlated with a direction a sound could be coming from, and when sound is detected the system applies each delay to the sound. Since each delay correlates to a different direction, the direction and intensity of the sound are mapped.

In the present invention, rather than relying solely on algorithmic solutions to determine locations, the system compares the amount of constructive interference created when mixing and combining signals together using preset delays. The system can then be supported by utilizing TDOA and/or triangulation principles to improve accuracy and reliability, but it is not required the system do so.

In some embodiments, the calibration configuration can be modified to account for variations in the medium such as, pressure, humidity or temperature as applicable. In some embodiments, the device may be further comprised of one or more temperature sensors which enable the device to predict the necessary delays based on the variations in the local speed of sound. In some embodiments, the device can be calibrated for use in other sound conducting media including underwater, inside solids, or otherwise gases or liquids besides typical Earth atmosphere.

By adding different delays, the system can be configured to listen to certain locations. This may be achieved by pre-inputting delays, or partially pre-inputting delays. For example, to create a delay to have the system listen to a location that is in-line with one of the acoustic sensors and at level with it, the delay would be calculated such that it is assumed the sound reaches the acoustic sensor in line with it first, then the other two lower sensors second simultaneously, and the top sensor last; because the speed of sound is known or can be accurately assumed, the delay can be derived from that. The next delay for a location slightly aside from that one would be input with the presumption that the sound arrives slightly later to the first sensor, to one of the side sensors slightly earlier and the other later, and to the top sensor later still depending on how far to the side the delay is being calculated. In some embodiments the system can be pre-programmed with the current constants for the speed of sound based on factors including, but not limited to, temperature and atmospheric pressure, or the system can include sensors capable of detecting such factors and internally adjusting the delays.

Thus, the system can be configured with a large range of delays so that it is able to generate a sound-intensity map of a three-dimensional area by breaking the area into a three-dimensional with three or more axes. The system would not be required to actively move the acoustic sensors but instead would be able to view a range of locations by adding different delays to the data collected by the acoustic sensors and using that as its targeting mechanism. In practice, the system functions thusly: a three-dimensional area around the system can be generalized as a sphere divided into a grid; a sound incoming from a specific sector on the grid and be listened to by utilizing a pre-set delay; and by then creating a delay for each sector on the grid—by having the delay for each location pre-calculated as if the sound had come from that location—the device can create a three-dimensional map of the local area around itself. Combined with proper display software the device can also create three-dimensional maps with certain sounds sources marked as “hot spots” on a form of heat-map of the local area which can be displayed relative to line-of-sight to the device and/or as a generalized map.

In some embodiments, the device can be combined with software and hardware solutions to isolate certain frequencies and allow for frequency specific delays to reduce error created due to artifacts from resonant frequencies. When searching for specific frequencies the device can be calibrated further to account for the frequency in question, adding a known delay based on the anticipated wavelength and arrival time of the frequency. Alternatively, the device can be configured to only listen for specified frequencies and/or wavelengths, or to look for them specifically in the data to pick them

When isolating based on frequency in addition to arrival time the present device is thus capable of creating a sound map that shows the relative strengths of sounds based on audio frequency bands for a given area. In some embodiments, the system may be configured to display the audio frequency strengths in various colors or other means of indicating the strengths of differing sounds. In such embodiments brightness may be associated with the signal strength of the signal after the signals have been combined.

In some embodiments, the system can be configured to ignore certain delays or ranges, thereby saving on processing power and improving overall speed and efficiency of the detection system to allow for a more rapid location. For example, were a user only concerned with sounds emanating from a certain range, such as the 180-degree semi-sphere presently in front of them, the system could be configured to input only delays that would result in sounds from that direction; essentially not triggering on acoustic sounds that are not first detected by the one or more acoustic detectors pointed in that direction.

The delay mixing component of the system can also enable the system to pick specific noises out of an otherwise high level of disruptive background noise. In some embodiments the system applies the delay to the input data received by each sensor and thus the delays allow the waveforms of the sudden, louder noise to constructively interfere, thus making them stand out over varying background noise which will usually not reach the same peak as the noise being listened for.

In some embodiments the system can be configured to reduce processing demand by taking the data from all the acoustic sensors, adding a pre-set delay to the data from each sensor, combining the delay-added datasets into single waveforms representing constructive interference from each dataset, reviewing each dataset to determine which has the highest recorded input value—in some embodiments this input may be in decibels—, determine which delay was added to the dataset with the highest recorded input value, determine which location that delay was programmed to orient towards, and then set the pixel associated with that location as the brightest. Then the system can look at the pixels around the highest and set their brightness lower but relative to the first pixel until the system reaches the lowest recorded input levels, which would be the darkest pixels.

In some embodiments, the acoustic location computation splits the x-y plane into six hexidrants with three of the seven axes emerging from the center and passing through the location of each of the three sensors, and the other three emerge halfway between each pair of sensors. The final sensor emerges from the z axis, perpendicular to the x-y plane. The axes between the sensors may be referred to as ideals because any incoming wave would be detected by the sensors the axes is located between at the same time. In effect, splitting the area around the three lower sensors into hexidrants allows the system to assume the basic direction from which a sound came based on which sensor detects it first. The first sensor to detect a sound thus means the sound came from one of the two hexidrants on either side of that sensor 104. The determination can be further honed by then determining when the other two horizontally aligned sensors detected the sound. If, relative to the sensor that detected the sound first, the one rightwards of it detects the sound second, then it can be presumed that the sound is coming from the right-side hexidrant relative to the first sensor.

Therefore, the same assumptive reasoning can be applied to the top sensor; a sound that is detected by a horizontal plane sensor will be detected first by a horizontal plane sensor unless the sound originates from above forty-five degrees over the device, in which case it will be detected by the top sensor before any of the horizontal sensors. In such cases the system can assume the sound is emanating from somewhere in the inverted cone with a forty-five degree slope originating out of the base of the device. Once that assumption is made the system can compute the relative direction based on when the other three sensors detect the sound.

In some embodiments, there are additional sensors and the computation splits the x-y plan, or another similar plane, into more segments based on the number and positioning of the sensors.

In some embodiments, an attached computer processor receives data on the received sounds from the acoustic sensors, and then plots the waveforms of that data to calculate which sensor detected the waveform first, and then calculates the location of the incoming sounds by comparing the times that the other sensors detected the sound to determine its direction based on the known speed of sound.

In some embodiments, an attached computer processor modifies the incoming sound data by inputting an artificial delay on the first three acoustic sensor waveforms and then combines the resulting waveform, allowing the device to amplify the incoming sound to better detect it from the noise of other incoming sounds. In some embodiments, an attached computer processor could take in data from multiple sounds and combine matching waveforms to generate an image of the surrounding sounds.

In some embodiments, the device includes a computer database and processor configured to compare the waveform of detected acoustic waves to a known library of acoustic waves to determine the cause of the acoustic wave. For example, the database may include the report of various firearms, and would be able to display for a user that a detected acoustic wave was likely the sound of a firearm discharging. In some embodiments, the device may include a display screen to provide information to a user.

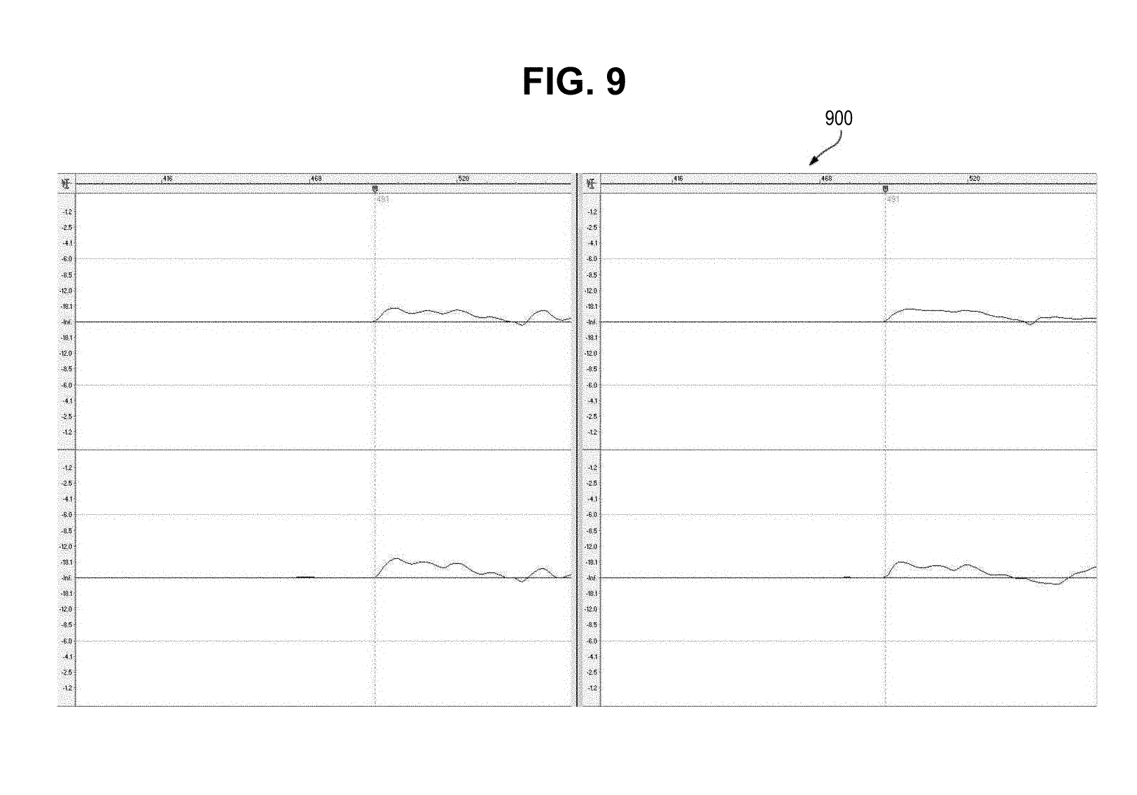

FIG. 9 is the zoomed-in, delay-added version of the data 900 detected by the acoustic sensor apparatus of a device and method for the three-dimensional detection of acoustic waves and the imaging when detecting a sudden, loud noise, in accordance with an embodiment of the invention.

In some embodiments, the present invention improves on conventional methods of acoustic detection which measure the time difference of arrival times (“TDOA”) of sound waves at certain acoustic sensors. In its simplest form the TDOA determines sound origination locations by measuring Δt, delta t, the time difference in seconds between when two sensors detect the sound, which is calculated by taking the distance between the two sensors, multiplied by the cosine of the baseline angle between them and the incident sound, over the speed of sound. Combining the known factors, a user can solve the equation for the cosine of the baseline angle, and from there find the baseline angle. In the present method, the speed of sound may be assumed given ordinary terrestrial circumstances, though can be modified based on the medium in the location being monitored or based on data detected by sensors, and an artificial delay is input into the data of the first and all but the last microphones to detect a sound so that the waveforms are constructively added to the original waveform to assist in distilling the incident noise from the surrounding noise.

This system and method combines some of the theory behind TDOA with triangulation principles given that the location of the sensors relative to each other is a known quantity and the speed of sound in a given medium is also known. In one embodiment, the system and method involve inverting part of the traditional TDOA calculation; instead of having a pre-programmed value for the speed of sound and comparing the exact time sounds were received directly, the system utilizes a number of pre-programmed delays that, when combined, correspond to the entire field around the device. The device then, rather than having to wait for each acoustic sensor to detect a sound and then work backwards from there, applies its modifications and delay to the data it receives from the acoustic sensors to be able to listen to multiple locations at the same time as demonstrated in the delay-added data 900. In some embodiments the system is configured with a number of different delays, each correlated with a direction a sound could be coming from, and when sound is detected the system applies each delay to the sound. Since each delay correlates to a different direction, the direction and intensity of the sound are mapped.

In the present invention, rather than relying solely on algorithmic solutions to determine locations, the system compares the amount of constructive interference created when mixing and combining signals together using preset delays. The system can then be supported by utilizing TDOA and/or triangulation principles to improve accuracy and reliability, but it is not required the system do so.

In some embodiments, the calibration configuration can be modified to account for variations in the medium such as, pressure, humidity or temperature as applicable. In some embodiments, the device may be further comprised of one or more temperature sensors which enable the device to predict the necessary delays based on the variations in the local speed of sound. In some embodiments, the device can be calibrated for use in other sound conducting media including underwater, inside solids, or otherwise gases or liquids besides typical Earth atmosphere.

By adding different delays, the system can be configured to listen to certain locations. This may be achieved by pre-inputting delays, or partially pre-inputting delays. For example, to create a delay to have the system listen to a location that is in-line with one of the acoustic sensors and at level with it, the delay would be calculated such that it is assumed the sound reaches the acoustic sensor in line with it first, then the other two lower sensors second simultaneously, and the top sensor last; because the speed of sound is known or can be accurately assumed, the delay can be derived from that. The next delay for a location slightly aside from that one would be input with the presumption that the sound arrives slightly later to the first sensor, to one of the side sensors slightly earlier and the other later, and to the top sensor later still depending on how far to the side the delay is being calculated. In some embodiments the system can be pre-programmed with the current constants for the speed of sound based on factors including, but not limited to, temperature and atmospheric pressure, or the system can include sensors capable of detecting such factors and internally adjusting the delays.

The delays utilized in the present invention could be conceived as a reversal of the traditional acoustic location calculation, wherein rather than utilizing the delay between each sensor to triangulate the location of the sound, the delays, pre-programmed as one or more sets, are already configured to look at various locations as if sound had come from them, so that instead the device can optionally focus on comparing and calculating the highest recorded intensities by combining the amplitudes of the waveforms after applying the delay to each data set 900, then comparing which delay set produced the largest amplitude waveform.

Thus, the system can be configured with a large range of delays so that it is able to generate a sound-intensity map of a three-dimensional area by breaking the area into a three-dimensional with three or more axes. The system would not be required to actively move the acoustic sensors but instead would be able to view a range of locations by adding different delays to the data collected by the acoustic sensors and using that as its targeting mechanism. In practice, the system functions thusly: a three-dimensional area around the system can be generalized as a sphere divided into a grid; a sound incoming from a specific sector on the grid and be listened to by utilizing a pre-set delay; and by then creating a delay for each sector on the grid—by having the delay for each location pre-calculated as if the sound had come from that location—the device can create a three-dimensional map of the local area around itself. Combined with proper display software the device can also create three-dimensional maps with certain sounds sources marked as “hot spots” on a form of heat-map of the local area which can be displayed relative to line-of-sight to the device and/or as a generalized map.

In some embodiments, the device can be combined with software and hardware solutions to isolate certain frequencies and allow for frequency specific delays to reduce error created due to artifacts from resonant frequencies. When searching for specific frequencies the device can be calibrated further to account for the frequency in question, adding a known delay based on the anticipated wavelength and arrival time of the frequency. Alternatively, the device can be configured to only listen for specified frequencies and/or wavelengths, or to look for them specifically in the data to pick them

When isolating based on frequency in addition to arrival time the present device is thus capable of creating a sound map that shows the relative strengths of sounds based on audio frequency bands for a given area. In some embodiments, the system may be configured to display the audio frequency strengths in various colors or other means of indicating the strengths of differing sounds. In such embodiments brightness may be associated with the signal strength of the signal after the signals have been combined.

In some embodiments, the system can be configured to ignore certain delays or ranges, thereby saving on processing power and improving overall speed and efficiency of the detection system to allow for a more rapid location. For example, were a user only concerned with sounds emanating from a certain range, such as the 180-degree semi-sphere presently in front of them, the system could be configured to input only delays that would result in sounds from that direction; essentially not triggering on acoustic sounds that are not first detected by the one or more acoustic detectors pointed in that direction.

The delay mixing component of the system can also enable the system to pick specific noises out of an otherwise high level of disruptive background noise. In some embodiments the system applies the delay to the input data received by each sensor and thus the delays allow the waveforms of the sudden, louder noise to constructively interfere, thus making them stand out over varying background noise which will usually not reach the same peak as the noise being listened for.

In some embodiments the system can be configured to reduce processing demand by taking the data from all the acoustic sensors, adding a pre-set delay to the data from each sensor 900, combining the delay-added datasets into single waveforms representing constructive interference from each dataset, reviewing each dataset to determine which has the highest recorded input value—in some embodiments this input may be in decibels—, determine which delay was added to the dataset with the highest recorded input value, determine which location that delay was programmed to orient towards, and then set the pixel associated with that location as the brightest. Then the system can look at the pixels around the highest and set their brightness lower but relative to the first pixel until the system reaches the lowest recorded input levels, which would be the darkest pixels.

In some embodiments, the acoustic location computation splits the x-y plane into six hexidrants with three of the seven axes emerging from the center and passing through the location of each of the three sensors, and the other three emerge halfway between each pair of sensors. The final sensor emerges from the z axis, perpendicular to the x-y plane. The axes between the sensors may be referred to as ideals because any incoming wave would be detected by the sensors the axes is located between at the same time. In effect, splitting the area around the three lower sensors into hexidrants allows the system to assume the basic direction from which a sound came based on which sensor detects it first. The first sensor to detect a sound thus means the sound came from one of the two hexidrants on either side of that sensor 104. The determination can be further honed by then determining when the other two horizontally aligned sensors detected the sound. If, relative to the sensor that detected the sound first, the one rightwards of it detects the sound second, then it can be presumed that the sound is coming from the right-side hexidrant relative to the first sensor.

Therefore, the same assumptive reasoning can be applied to the top sensor; a sound that is detected by a horizontal plane sensor will be detected first by a horizontal plane sensor unless the sound originates from above forty-five degrees over the device, in which case it will be detected by the top sensor before any of the horizontal sensors. In such cases the system can assume the sound is emanating from somewhere in the inverted cone with a forty-five degree slope originating out of the base of the device. Once that assumption is made the system can compute the relative direction based on when the other three sensors detect the sound.

In some embodiments, there are additional sensors and the computation splits the x-y plan, or another similar plane, into more segments based on the number and positioning of the sensors.

In some embodiments, an attached computer processor receives data on the received sounds from the acoustic sensors, and then plots the waveforms of that data to calculate which sensor detected the waveform first, and then calculates the location of the incoming sounds by comparing the times that the other sensors detected the sound to determine its direction based on the known speed of sound.

In some embodiments, an attached computer processor modifies the incoming sound data by inputting an artificial delay on the first three acoustic sensor waveforms and then combines the resulting waveform, allowing the device to amplify the incoming sound to better detect it from the noise of other incoming sounds. In some embodiments, an attached computer processor could take in data from multiple sounds and combine matching waveforms to generate an image of the surrounding sounds.

In some embodiments, the device includes a computer database and processor configured to compare the waveform of detected acoustic waves to a known library of acoustic waves to determine the cause of the acoustic wave. For example, the database may include the report of various firearms, and would be able to display for a user that a detected acoustic wave was likely the sound of a firearm discharging. In some embodiments, the device may include a display screen to provide information to a user.

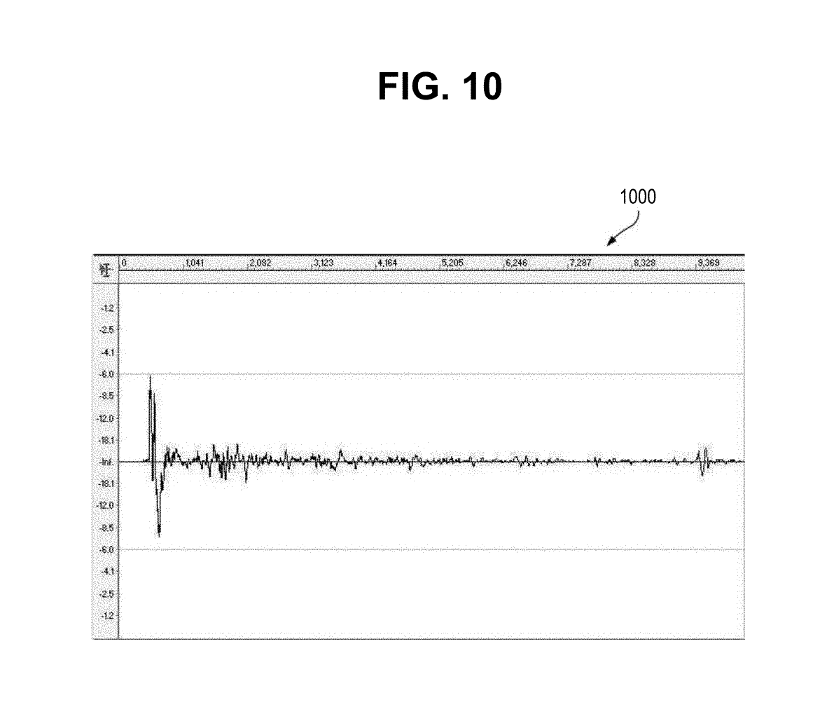

FIG. 10 is the combined data 1000 from four acoustic sensors of a device and method for the three-dimensional detection of acoustic waves and the locating and imaging thereof with the delay added, in accordance with an embodiment of the invention.

In some embodiments, the present invention improves on conventional methods of acoustic detection which measure the time difference of arrival times (“TDOA”) of sound waves at certain acoustic sensors. In its simplest form the TDOA determines sound origination locations by measuring Δt, delta t, the time difference in seconds between when two sensors detect the sound, which is calculated by taking the distance between the two sensors, multiplied by the cosine of the baseline angle between them and the incident sound, over the speed of sound. Combining the known factors, a user can solve the equation for the cosine of the baseline angle, and from there find the baseline angle. In the present method, the speed of sound may be assumed given ordinary terrestrial circumstances, though can be modified based on the medium in the location being monitored or based on data detected by sensors, and an artificial delay is input into the data of the first and all but the last microphones to detect a sound so that the waveforms are constructively added to the original waveform to assist in distilling the incident noise from the surrounding noise.

This system and method combines some of the theory behind TDOA with triangulation principles given that the location of the sensors relative to each other is a known quantity and the speed of sound in a given medium is also known. In one embodiment, the system and method involve inverting part of the traditional TDOA calculation; instead of having a pre-programmed value for the speed of sound and comparing the exact time sounds were received directly, the system utilizes a number of pre-programmed delays that, when combined, correspond to the entire field around the device. The device then, rather than having to wait for each acoustic sensor to detect a sound and then work backwards from there, applies its modifications and delay to the data it receives from the acoustic sensors to be able to listen to multiple locations at the same time. In some embodiments the system is configured with a number of different delays, each correlated with a direction a sound could be coming from, and when sound is detected the system applies each delay to the sound. Since each delay correlates to a different direction, the direction and intensity of the sound are mapped.

In the present invention, rather than relying solely on algorithmic solutions to determine locations, the system compares the amount of constructive interference created when mixing and combining signals together using preset delays. The system can then be supported by utilizing TDOA and/or triangulation principles to improve accuracy and reliability, but it is not required the system do so.

In some embodiments, the calibration configuration can be modified to account for variations in the medium such as, pressure, humidity or temperature as applicable. In some embodiments, the device may be further comprised of one or more temperature sensors which enable the device to predict the necessary delays based on the variations in the local speed of sound. In some embodiments, the device can be calibrated for use in other sound conducting media including underwater, inside solids, or otherwise gases or liquids besides typical Earth atmosphere.

By adding different delays, the system can be configured to listen to certain locations. This may be achieved by pre-inputting delays, or partially pre-inputting delays. For example, to create a delay to have the system listen to a location that is in-line with one of the acoustic sensors and at level with it, the delay would be calculated such that it is assumed the sound reaches the acoustic sensor in line with it first, then the other two lower sensors second simultaneously, and the top sensor last; because the speed of sound is known or can be accurately assumed, the delay can be derived from that. The next delay for a location slightly aside from that one would be input with the presumption that the sound arrives slightly later to the first sensor, to one of the side sensors slightly earlier and the other later, and to the top sensor later still depending on how far to the side the delay is being calculated. In some embodiments the system can be pre-programmed with the current constants for the speed of sound based on factors including, but not limited to, temperature and atmospheric pressure, or the system can include sensors capable of detecting such factors and internally adjusting the delays.

The delays utilized in the present invention could be conceived as a reversal of the traditional acoustic location calculation, wherein rather than utilizing the delay between each sensor to triangulate the location of the sound, the delays, pre-programmed as one or more sets, are already configured to look at various locations as if sound had come from them, so that instead the device can optionally focus on comparing and calculating the highest recorded intensities by combining 1000 the amplitudes of the waveforms after applying the delay to each data set, then comparing which delay set produced the largest amplitude waveform.

Thus, the system can be configured with a large range of delays so that it is able to generate a sound-intensity map of a three-dimensional area by breaking the area into a three-dimensional with three or more axes. The system would not be required to actively move the acoustic sensors but instead would be able to view a range of locations by adding different delays to the data collected by the acoustic sensors and using that as its targeting mechanism. In practice, the system functions thusly: a three-dimensional area around the system can be generalized as a sphere divided into a grid; a sound incoming from a specific sector on the grid and be listened to by utilizing a pre-set delay; and by then creating a delay for each sector on the grid—by having the delay for each location pre-calculated as if the sound had come from that location—the device can create a three-dimensional map of the local area around itself. Combined with proper display software the device can also create three-dimensional maps with certain sounds sources marked as “hot spots” on a form of heat-map of the local area which can be displayed relative to line-of-sight to the device and/or as a generalized map.

In some embodiments, the device can be combined with software and hardware solutions to isolate certain frequencies and allow for frequency specific delays to reduce error created due to artifacts from resonant frequencies. When searching for specific frequencies the device can be calibrated further to account for the frequency in question, adding a known delay based on the anticipated wavelength and arrival time of the frequency. Alternatively, the device can be configured to only listen for specified frequencies and/or wavelengths, or to look for them specifically in the data to pick them

When isolating based on frequency in addition to arrival time the present device is thus capable of creating a sound map that shows the relative strengths of sounds based on audio frequency bands for a given area. In some embodiments, the system may be configured to display the audio frequency strengths in various colors or other means of indicating the strengths of differing sounds. In such embodiments brightness may be associated with the signal strength of the signal after the signals have been combined.

In some embodiments, the system can be configured to ignore certain delays or ranges, thereby saving on processing power and improving overall speed and efficiency of the detection system to allow for a more rapid location. For example, were a user only concerned with sounds emanating from a certain range, such as the 180-degree semi-sphere presently in front of them, the system could be configured to input only delays that would result in sounds from that direction; essentially not triggering on acoustic sounds that are not first detected by the one or more acoustic detectors pointed in that direction.

The delay mixing component of the system can also enable the system to pick specific noises out of an otherwise high level of disruptive background noise. In some embodiments the system applies the delay to the input data received by each sensor and thus the delays allow the waveforms of the sudden, louder noise to constructively interfere, thus making them stand out over varying background noise which will usually not reach the same peak as the noise being listened for.

In some embodiments the system can be configured to reduce processing demand by taking the data from all the acoustic sensors, adding a pre-set delay to the data from each sensor, combining the delay-added datasets into single waveforms representing constructive interference from each dataset 1000, reviewing each dataset to determine which has the highest recorded input value—in some embodiments this input may be in decibels—, determine which delay was added to the dataset with the highest recorded input value, determine which location that delay was programmed to orient towards, and then set the pixel associated with that location as the brightest. Then the system can look at the pixels around the highest and set their brightness lower but relative to the first pixel until the system reaches the lowest recorded input levels, which would be the darkest pixels.

In some embodiments, the acoustic location computation splits the x-y plane into six hexidrants with three of the seven axes emerging from the center and passing through the location of each of the three sensors, and the other three emerge halfway between each pair of sensors. The final sensor emerges from the z axis, perpendicular to the x-y plane. The axes between the sensors may be referred to as ideals because any incoming wave would be detected by the sensors the axes is located between at the same time. In effect, splitting the area around the three lower sensors into hexidrants allows the system to assume the basic direction from which a sound came based on which sensor detects it first. The first sensor to detect a sound thus means the sound came from one of the two hexidrants on either side of that sensor 104. The determination can be further honed by then determining when the other two horizontally aligned sensors detected the sound. If, relative to the sensor that detected the sound first, the one rightwards of it detects the sound second, then it can be presumed that the sound is coming from the right-side hexidrant relative to the first sensor.

Therefore, the same assumptive reasoning can be applied to the top sensor; a sound that is detected by a horizontal plane sensor will be detected first by a horizontal plane sensor unless the sound originates from above forty-five degrees over the device, in which case it will be detected by the top sensor before any of the horizontal sensors. In such cases the system can assume the sound is emanating from somewhere in the inverted cone with a forty-five degree slope originating out of the base of the device. Once that assumption is made the system can compute the relative direction based on when the other three sensors detect the sound.

In some embodiments, there are additional sensors and the computation splits the x-y plan, or another similar plane, into more segments based on the number and positioning of the sensors.

In some embodiments, an attached computer processor receives data on the received sounds from the acoustic sensors, and then plots the waveforms of that data to calculate which sensor detected the waveform first, and then calculates the location of the incoming sounds by comparing the times that the other sensors detected the sound to determine its direction based on the known speed of sound.

In some embodiments, an attached computer processor modifies the incoming sound data by inputting an artificial delay on the first three acoustic sensor waveforms and then combines the resulting waveform, allowing the device to amplify the incoming sound to better detect it from the noise of other incoming sounds. In some embodiments, an attached computer processor could take in data from multiple sounds and combine matching waveforms to generate an image of the surrounding sounds.

In some embodiments, the device includes a computer database and processor configured to compare the waveform of detected acoustic waves to a known library of acoustic waves to determine the cause of the acoustic wave. For example, the database may include the report of various firearms, and would be able to display for a user that a detected acoustic wave was likely the sound of a firearm discharging. In some embodiments, the device may include a display screen to provide information to a user.

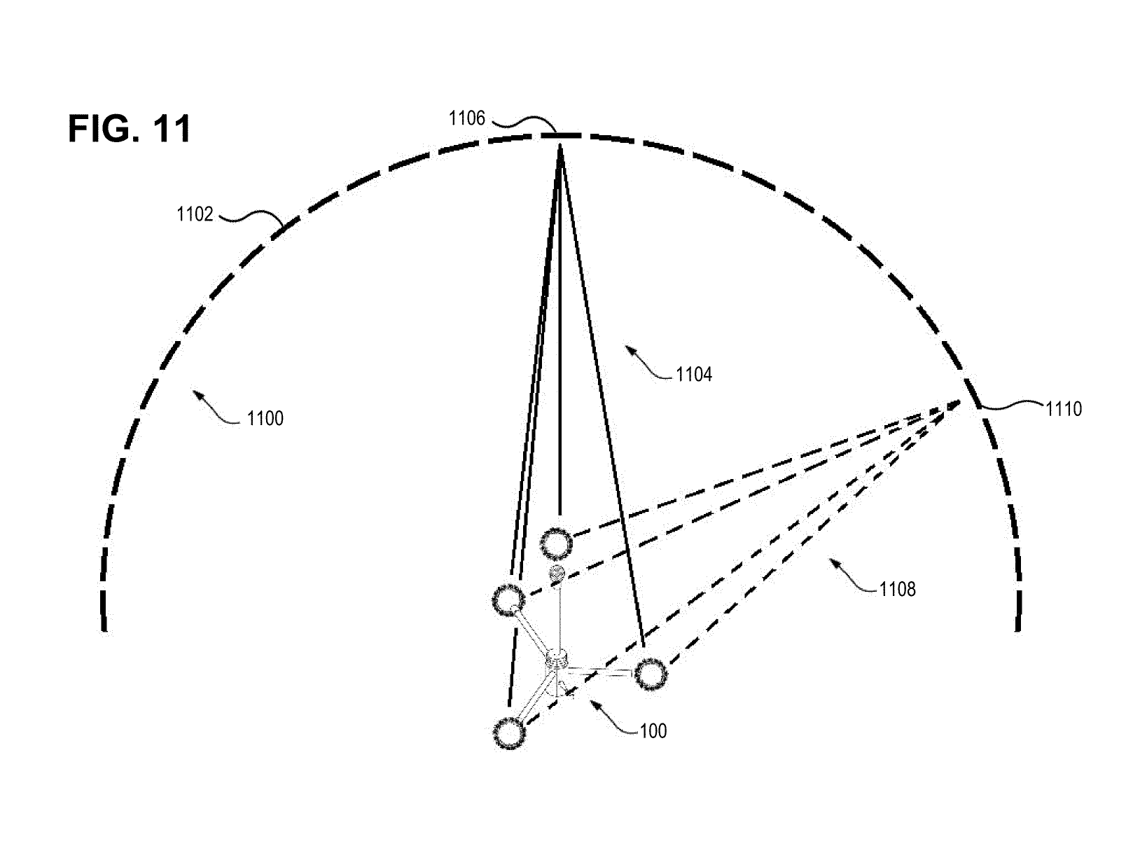

FIG. 11 is a perspective view of a simulated version of how the device and method for the three-dimensional detection of acoustic waves and the locating and imaging thereof inputs delays, in accordance with an embodiment of the invention.

In some embodiments, an acoustic sensor apparatus 100 is pre-programed with a set of delays that implicitly assume a direction that sound is coming from which can be mapped to a three-dimensional sphere, displayed in FIG. 11 in two dimensions as a circle 1100, around the acoustic sensor apparatus 100. The three-dimensional sphere may be mathematically assumed to actually be comprised of infinitely small polygons, or pixels, in three dimensions, or line segments 1102 for the circle when representing the device in two dimensions, with each of those line segments 1102 that make up the circle 1100 is associated with a delay. The solid line cluster 1104 therefore represents the situation wherein the delay is input that would steer the device towards listening to a specific line segment 1106 that represents a specific area in space, while the dashed line cluster 1108 represents a delay that is input to steer the device towards specific point 1110. In essence the, instead of using the incoming sound waves or other detected input to determine the location of the incoming sound, the system uses delays that fill in that data and look at the entire area around the acoustic sensor apparatus 100 by bringing in data and applying all the delays to it. Depending on the level of processing power available and the level of detail required the size of the pixels can be modified as large or as small as is desired.

The delays utilized in the present invention could be conceived as a reversal of the traditional acoustic location calculation, wherein rather than utilizing the delay between each sensor to triangulate the location of the sound, the delays, pre-programmed as one or more sets, are already configured to look at various locations as if sound had come from them, so that instead the device can optionally focus on comparing and calculating the highest recorded intensities by combining the amplitudes of the waveforms after applying the delay to each data set, then comparing which delay set produced the largest amplitude waveform.

In some embodiments, the present invention improves on conventional methods of acoustic detection which measure the time difference of arrival times (“TDOA”) of sound waves at certain acoustic sensors. In its simplest form the TDOA determines sound origination locations by measuring Δt, delta t, the time difference in seconds between when two sensors detect the sound, which is calculated by taking the distance between the two sensors, multiplied by the cosine of the baseline angle between them and the incident sound, over the speed of sound. Combining the known factors, a user can solve the equation for the cosine of the baseline angle, and from there find the baseline angle. In the present method, the speed of sound may be assumed given ordinary terrestrial circumstances, though can be modified based on the medium in the location being monitored or based on data detected by sensors, and an artificial delay is input into the data of the first and all but the last microphones to detect a sound so that the waveforms are constructively added to the original waveform to assist in distilling the incident noise from the surrounding noise.

This system and method combines some of the theory behind TDOA with triangulation principles given that the location of the sensors relative to each other is a known quantity and the speed of sound in a given medium is also known. In one embodiment, the system and method involve inverting part of the traditional TDOA calculation; instead of having a pre-programmed value for the speed of sound and comparing the exact time sounds were received directly, the system utilizes a number of pre-programmed delays that, when combined, correspond to the entire field around the device. The device then, rather than having to wait for each acoustic sensor to detect a sound and then work backwards from there, applies its modifications and delay to the data it receives from the acoustic sensors to be able to listen to multiple locations at the same time. In some embodiments the system is configured with a number of different delays, each correlated with a direction a sound could be coming from, and when sound is detected the system applies each delay to the sound. Since each delay correlates to a different direction, the direction and intensity of the sound are mapped.

In the present invention, rather than relying solely on algorithmic solutions to determine locations, the system compares the amount of constructive interference created when mixing and combining signals together using preset delays. The system can then be supported by utilizing TDOA and/or triangulation principles to improve accuracy and reliability, but it is not required the system do so.

In some embodiments, the calibration configuration can be modified to account for variations in the medium such as, pressure, humidity or temperature as applicable. In some embodiments, the device may be further comprised of one or more temperature sensors which enable the device to predict the necessary delays based on the variations in the local speed of sound. In some embodiments, the device can be calibrated for use in other sound conducting media including underwater, inside solids, or otherwise gases or liquids besides typical Earth atmosphere.

By adding different delays, the system can be configured to listen to certain locations. This may be achieved by pre-inputting delays, or partially pre-inputting delays. For example, to create a delay to have the system listen to a location that is in-line with one of the acoustic sensors and at level with it, the delay would be calculated such that it is assumed the sound reaches the acoustic sensor in line with it first, then the other two lower sensors second simultaneously, and the top sensor last; because the speed of sound is known or can be accurately assumed, the delay can be derived from that. The next delay for a location slightly aside from that one would be input with the presumption that the sound arrives slightly later to the first sensor, to one of the side sensors slightly earlier and the other later, and to the top sensor later still depending on how far to the side the delay is being calculated. In some embodiments the system can be pre-programmed with the current constants for the speed of sound based on factors including, but not limited to, temperature and atmospheric pressure, or the system can include sensors capable of detecting such factors and internally adjusting the delays.

Thus, the system can be configured with a large range of delays so that it is able to generate a sound-intensity map of a three-dimensional area by breaking the area into a three-dimensional with three or more axes. The system would not be required to actively move the acoustic sensors but instead would be able to view a range of locations by adding different delays to the data collected by the acoustic sensors and using that as its targeting mechanism. In practice, the system functions thusly: a three-dimensional area around the system can be generalized as a sphere divided into a grid; a sound incoming from a specific sector on the grid and be listened to by utilizing a pre-set delay; and by then creating a delay for each sector on the grid—by having the delay for each location pre-calculated as if the sound had come from that location—the device can create a three-dimensional map of the local area around itself. Combined with proper display software the device can also create three-dimensional maps with certain sounds sources marked as “hot spots” on a form of heat-map of the local area which can be displayed relative to line-of-sight to the device and/or as a generalized map.

In some embodiments, the device can be combined with software and hardware solutions to isolate certain frequencies and allow for frequency specific delays to reduce error created due to artifacts from resonant frequencies. When searching for specific frequencies the device can be calibrated further to account for the frequency in question, adding a known delay based on the anticipated wavelength and arrival time of the frequency. Alternatively, the device can be configured to only listen for specified frequencies and/or wavelengths, or to look for them specifically in the data to pick them

When isolating based on frequency in addition to arrival time the present device is thus capable of creating a sound map that shows the relative strengths of sounds based on audio frequency bands for a given area. In some embodiments, the system may be configured to display the audio frequency strengths in various colors or other means of indicating the strengths of differing sounds. In such embodiments brightness may be associated with the signal strength of the signal after the signals have been combined.

In some embodiments, the system can be configured to ignore certain delays or ranges, thereby saving on processing power and improving overall speed and efficiency of the detection system to allow for a more rapid location. For example, were a user only concerned with sounds emanating from a certain range, such as the 180-degree semi-sphere presently in front of them, the system could be configured to input only delays that would result in sounds from that direction; essentially not triggering on acoustic sounds that are not first detected by the one or more acoustic detectors pointed in that direction.

The delay mixing component of the system can also enable the system to pick specific noises out of an otherwise high level of disruptive background noise. In some embodiments the system applies the delay to the input data received by each sensor and thus the delays allow the waveforms of the sudden, louder noise to constructively interfere, thus making them stand out over varying background noise which will usually not reach the same peak as the noise being listened for.

In some embodiments the system can be configured to reduce processing demand by taking the data from all the acoustic sensors, adding a pre-set delay to the data from each sensor, combining the delay-added datasets into single waveforms representing constructive interference from each dataset, reviewing each dataset to determine which has the highest recorded input value—in some embodiments this input may be in decibels—, determine which delay was added to the dataset with the highest recorded input value, determine which location that delay was programmed to orient towards, and then set the pixel associated with that location as the brightest. Then the system can look at the pixels around the highest and set their brightness lower but relative to the first pixel until the system reaches the lowest recorded input levels, which would be the darkest pixels.

In some embodiments, the acoustic location computation splits the x-y plane into six hexidrants with three of the seven axes emerging from the center and passing through the location of each of the three sensors, and the other three emerge halfway between each pair of sensors. The final sensor emerges from the z axis, perpendicular to the x-y plane. The axes between the sensors may be referred to as ideals because any incoming wave would be detected by the sensors the axes is located between at the same time. In effect, splitting the area around the three lower sensors into hexidrants allows the system to assume the basic direction from which a sound came based on which sensor detects it first. The first sensor to detect a sound thus means the sound came from one of the two hexidrants on either side of that sensor 104. The determination can be further honed by then determining when the other two horizontally aligned sensors detected the sound. If, relative to the sensor that detected the sound first, the one rightwards of it detects the sound second, then it can be presumed that the sound is coming from the right-side hexidrant relative to the first sensor.

Therefore, the same assumptive reasoning can be applied to the top sensor; a sound that is detected by a horizontal plane sensor will be detected first by a horizontal plane sensor unless the sound originates from above forty-five degrees over the device, in which case it will be detected by the top sensor before any of the horizontal sensors. In such cases the system can assume the sound is emanating from somewhere in the inverted cone with a forty-five degree slope originating out of the base of the device. Once that assumption is made the system can compute the relative direction based on when the other three sensors detect the sound.

In some embodiments, there are additional sensors and the computation splits the x-y plan, or another similar plane, into more segments based on the number and positioning of the sensors.

In some embodiments, an attached computer processor receives data on the received sounds from the acoustic sensors, and then plots the waveforms of that data to calculate which sensor detected the waveform first, and then calculates the location of the incoming sounds by comparing the times that the other sensors detected the sound to determine its direction based on the known speed of sound.

In some embodiments, an attached computer processor modifies the incoming sound data by inputting an artificial delay on the first three acoustic sensor waveforms and then combines the resulting waveform, allowing the device to amplify the incoming sound to better detect it from the noise of other incoming sounds. In some embodiments, an attached computer processor could take in data from multiple sounds and combine matching waveforms to generate an image of the surrounding sounds.

In some embodiments, the device includes a computer database and processor configured to compare the waveform of detected acoustic waves to a known library of acoustic waves to determine the cause of the acoustic wave. For example, the database may include the report of various firearms, and would be able to display for a user that a detected acoustic wave was likely the sound of a firearm discharging. In some embodiments, the device may include a display screen to provide information to a user.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects. It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices, systems, and/or processes via the use of diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Accordingly, the scope of the invention is not limited by the disclosure of these preferred and alternate embodiments. Instead, the invention should be determined by reference to the claims that follow.

What is claimed is:

1. A system for three-dimensional acoustic detection, the system comprised of:
one or more acoustic sensors configured to collect one or more sets of acoustic data; and
a computer processor configured to perform operations including at least:
obtaining one or more sets of acoustic data from the one or more acoustic sensors;
applying one or more time delays to the one or more sets of acoustic data from the one or more acoustic sensors to create one or more sets of delay data; and
combining the one or more sets of delay data from the one or more acoustic sensors into one or more sets of output data.

2. The system for three-dimensional detection of claim 1, wherein the computer processor is further configured to perform operations including at least:
determining which of the one or more sets of output data has the highest level of input recorded.

3. The system for three-dimensional detection of claim 2, wherein the computer processor is further configured to perform operations including at least:
determining which of the one or more delays is associated with the set of output data that has the highest level of input recorded and determining a direction the one or more sets of acoustic data came from based on which of the one or more delays resulted in a highest level of input.

4. The system for three-dimensional detection of claim 2, wherein the computer processor is further configured to perform operations including at least:
associating each of the one or more sets of delay data with a known direction relative to the one or more acoustic sensors to create one or more pixels.

5. The system for three-dimensional detection of claim 4, wherein the computer processor is further configured to perform operations including at least:
generating a sound map of an area surrounding the one or more acoustic sensors by mapping each of the one or more pixels onto a three-dimensional field based on the known direction.

6. The system for three-dimensional detection of claim 1, wherein the one or more acoustic sensors are four acoustic sensors with one positioned at each of the vertices of a tetrahedron.

7. The system of claim 6, wherein the system further comprises:
a base unit comprised of:
a computer processor configured to receive data from the number of acoustic sensors.

8. The system of claim 7, wherein the computer processor is further configured to calculate the difference in time between when any given acoustic sensor of the number of sensors detects one or more acoustic waves.

9. The system of claim 8, wherein the computer processor is further configured to add together the detected one or more acoustic waves and combine them into a single waveform.

10. The system of claim 9, wherein the computer processor is further configured to add a delay to the acoustic wave one or more acoustic waves s of all but the last sensor equal to the time between a given sensor detecting the one or more acoustic waves and the time the last sensor detected the acoustic wave.

11. The system of claim 10, wherein the computer processor is further configured to calculate an origination direction of one or more acoustic waves' source upon the detection of one or more acoustic waves of a specified amplitude by any of the number of sensors by calculating the highest amplitude of the detected one or more acoustic waves detected by the one or more acoustic sensors.

12. The system of claim 11, wherein the computer processor is further configured to calculate the origination direction of an acoustic wave source upon the detection of an acoustic wave of a specified frequency and a specified amplitude.

13. The system of claim 12, wherein the system is further comprised of a database of known acoustic waveforms and the computer processor takes data from the sensors and compares any detected acoustic waveforms to known acoustic waveforms.

14. The system of claim 13, wherein the system is further comprised of a display screen that is configured to display the acoustic waves detected and any known acoustic waveforms of similar shape.

15. The system of claim 5, wherein the computer processor is further configured to perform operations including at least:
divided an area surrounding the one or more acoustic sensors into a number of equal parts.

16. The system of claim 15, wherein the number of equal parts is six, and the area is divided radially around an axis represented by a line that intersects a center point of three of the one or more sensors and a fourth of the one or more sensors.

17. The system of claim 5, wherein the system is further comprised of:
one or more thermal sensors; and
the computer processor is configured to perform further operations:
receiving data from the one or more thermal sensors; and
adjusting the one or more time delays based on the data from the one or more thermal sensors.

18. The system of claim 17, wherein the system is further comprised of:
one or more pressure sensors; and
the computer processor is configured to perform further operations:
receiving data from the one or more pressure sensors; and
adjusting the one or more time delays based on the data from the one or more thermal sensors and one or more pressure sensors.

19. A method for the three-dimensional detection of acoustic waves, the method comprising:
detecting a signal from each of a number of acoustic sensors;
determining which sensor received the signal first;
dividing a horizontal plane around the number of acoustic sensors into six equal hexidrants;
calculating the difference in time between the detection of the acoustic wave;
adding a delay to each acoustic sensor input based on when the last of the acoustic sensors detected the acoustic wave;
combining the acoustic sensor input of each acoustic sensor to amplify the detected acoustic wave;
repeating the previous steps for one or more additional pre-set delays; and
mapping the location of incoming sounds based on a largest combined acoustic sensor input detected for each incoming sound onto a sound map.

20. The method of claim 19, the method further comprising:
determining the largest combined acoustic sensor input detected of all acoustic sensor inputs;
assigning a color to the largest combined acoustic sensor input's location on the sound map; and
assigning colors to the remaining combined acoustic sensor inputs based on their intensity relative to the largest combined acoustic sensor input.
